(19) United States
(12) Patent Application Publication
(10) Pub. No.: US 2025/0165461 A1
(43) Pub. Date: May 22, 2025

(54) TECHNIQUES FOR PROTECTIVE VALIDATION IN INDEX NODES OF A DISTRIBUTED DATABASE

(71) Applicant: Regatta Data Ltd., Bet Hanania (IL)

(72) Inventors: Erez WEBMAN, Petach Tikva (IL); Irit YADIN-LEMPEL, Caesarea (IL); Nitzan ZAMIR, Binyamina (IL); Roy Zeev GOLDSTEIN, Zikhron Ya'akov (IL)

(73) Assignee: Regatta Data Ltd., Bet Hanania (IL)

(21) Appl. No.: 18/947,848

(22) Filed: Nov. 14, 2024

Related U.S. Application Data
(60) Provisional application No. 63/600,145, filed on Nov. 17, 2023.

(51) Int. Cl. G06F 16/23; G06F 16/27

(52) U.S. Cl. CPC G06F 16/2379; G06F 16/27

(57) ABSTRACT

The method and system may include, during an index-validation process on index write operations of a transaction, identifying index-conflicts between a transaction and at least one reading-transaction; for each identified index-conflict, initiating a foreign instantiation to determine if the transaction can commit before the at least one reading-transaction; and upon completing the foreign instantiations on all identified index-conflicts and when validation conditions are met, placing a commit pause on the index-entries modified by the transaction. The method and system may also include initiating the foreign instantiation of a read-vector entry (RV-entry) in a table-node, wherein the RV-entry corresponds to a predicate of a reading-transaction performing an index search on an index node.

### CROSS-REFERENCE TO RELATED APPLICATIONS

This application claims the benefit of U.S. Provisional Application No. 63/600,145 filed on Nov. 17, 2023, the contents of which are hereby incorporated by reference.

The subject matter of the present application relates to U.S. patent application Ser. No. 18/341,279 filed on Jun. 26, 2023. The contents of the application Ser. No. 18/341,279 are hereby incorporated by reference. The subject matter of the present application also relates to U.S. patent application Ser. No. 18/944,462 filed on Nov. 12, 2024. The contents of the application Ser. No. 18/944,462 are hereby incorporated by reference. The subject matter of the present application also relates to U.S. patent application Ser. No. 18/945,062 filed on Nov. 12, 2024. The contents of the application Ser. No. 18/945,062 are hereby incorporated by reference.

### TECHNICAL FIELD

The present disclosure generally relates to databases and, specifically, techniques for the implementation of a concurrency control protocol to maintain the serializability of concurrent operations in such databases.

### BACKGROUND

In databases, concurrency control protocols ensure correct results for concurrent operations are generated as quickly as possible. Typically, a concurrency control protocol provides rules and methods typically applied by the database mechanisms to maintain the consistency of transactions operating concurrently and, thus, the consistency and correctness of the whole database. Introducing concurrency control into a database would apply operation constraints which typically result in some performance reduction. Operation consistency and correctness should be achieved as efficiently as possible without reducing the database's performance. However, a concurrency control protocol can require significant additional complexity and overhead in a concurrent algorithm compared to a simpler sequential algorithm.

A concurrency control protocol can be implemented in database management systems, transactional objects, and distributed applications. Such a protocol is designed to ensure that database transactions may be performed concurrently without violating the data integrity of the respective databases. Thus, concurrency control is an essential element for correctness in any database system where two database transactions or more, executed with time overlap, can access the same data, e.g., in virtually any general-purpose database system. There are different approaches to implementing a concurrency control protocol (or mechanism) in databases. The main approaches may be categorized as optimistic approaches and pessimistic approaches.

In some optimistic approaches, a check for whether a transaction meets the isolation and other integrity rules (e.g., serializability) is typically performed when the transaction ends, without blocking any of the transaction's operations. Other optimistic approaches check whether a transaction meets the isolation and other integrity rules (e.g., serializability), without blocking any of the transaction's operations. When the isolation of the transaction is violated, the transaction is aborted. An aborted transaction may be immediately restarted and re-executed, which incurs an overhead. As such, if too many transactions are aborted, the optimistic approach may be disadvantageous. In a pessimistic approach, an operation of a transaction is blocked when such an operation may cause a violation of consistency rules. In such cases, the operation is blocked until the possibility of violation of the transaction clears. The disadvantage of blocking operations involves performance reduction.

Different approaches for concurrency control in databases provide different levels of performance. The selection of the best-performing approach may be based on the type of transactions, the required performance, the type of databases, and the applications accessing the database. However, the selection and knowledge about trade-offs are not always available, and thus the implemented concurrency control approach may not be selected to provide the highest performance.

Further, some databases are designed where Atomicity, Consistency, Isolation, and Durability (ACID) requirements are relaxed. In such databases, as multiple transactions can execute concurrently and independently of each other, such transactions may overlap in their access to data. This could result in various inconsistencies. One method to ensure isolation between transactions and serialization in execution is by means of a well-designed concurrency control protocol.

Furthermore, existing concurrency control protocols are not efficient for transactions that include one or more predicates. Specifically, such protocols require placing locks or pausing the execution of transactions regardless of the states of the transactions' predicates. In databases, a predicate is a conditional (i.e., Boolean) expression that returns TRUE or FALSE. Predicates are commonly used in statements sent to databases and are often an inherent part of the database statement syntax or language. For example, a common usage of predicates would be to conditionally modify a data-cell(s) based on a condition that is based on data-cell(s). Another use of predicates in a relational database is when selecting one or more rows in a table. The selected rows are those for which the predicate evaluation, based on the contents of the row, returns TRUE. These selected rows can then be further acted upon.

It would, therefore, be advantageous to provide an improved concurrency control protocol for optimizing the performance of databases when executing transactions with predicates.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include: during an index-validation process on index write operations of a transaction, identifying index-conflicts between a transaction and at least one reading-transaction; for each identified index-conflict, initiating a foreign instantiation to determine if the transaction can commit before the at least one reading-transaction; upon completing the foreign instantiations on all identified index-conflicts and when validation conditions are met, placing a commit pause on the index-entries modified by the transaction. Other embodiments of this aspect include corresponding computer systems, apparatus, and computer programs recorded on one or more computer storage devices, each configured to perform the actions of the methods.

In one general aspect, a non-transitory computer-readable medium may include one or more instructions that, when executed by one or more processors of a device, cause the device to: during an index-validation process on index write operations of a transaction, identify index-conflicts between a transaction and at least one reading-transaction; for each identified index-conflict, initiate a foreign instantiation to determine if the transaction can commit before the at least one reading-transaction; and upon completing the foreign instantiations on all identified index-conflicts and when validation conditions are met, place a commit pause on the index-entries modified by the transaction. Other embodiments of this aspect include corresponding computer systems, apparatus, and computer programs recorded on one or more computer storage devices, each configured to perform the actions of the methods.

In one general aspect, a system may include one or more processors configured to: dure an index-validation process on index write operations of a transaction, identify index-conflicts between a transaction and at least one reading-transaction; for each identified index-conflict, initiate a foreign instantiation to determine if the transaction can commit before the at least one reading-transaction; upon completing the foreign instantiations on all identified index-conflicts and when validation conditions are met, place a commit pause on the index-entries modified by the transaction. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a distributed computing environment utilized to describe the various disclosed embodiments.

FIG. 2 is a block diagram of a database system arranged according to an embodiment.

FIG. 3 is a flowchart of a method of operation of a transaction manager, according to an embodiment.

FIG. 4 is a flowchart of an example process illustrating the operation of an index-validation phase and commit phase in an index-node of the predictive CCP according to one embodiment.

FIG. 5 is an example flowchart describing the operation of an index-validation of the predictive CCP according to one embodiment.

FIG. 6 illustrates an example flowchart of a process for performing an index read/search in the sufficient-instantiation technique according to an embodiment.

FIG. 7 is an example schematic diagram of a hardware layer of a node in a database according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, numerals refer to like parts from several perspectives.

Some example embodiments provide a predictive concurrency control protocol implemented into a database system (or simply a database). According to the disclosed embodiments, consistency of transactions, by means of the disclosed protocol, is achieved through isolating transactions and adopting different approaches during the execution phases of a transaction. In an embodiment, an optimistic approach is implemented during the working phase of a transaction to allow the operation of multiple transactions to run independently without blocking or locks. For validation of a transaction, a pessimistic approach is taken, where a validating transaction may wait for other transaction(s) to commit, and where, under some circumstances, a transaction that evaluated predicates may not block other validating transaction(s) from committing. This is achieved by predicting the value of such predicates in a transaction being validated. The prediction of values of such predicates for data-cells is achieved, in some embodiments, through an epsilon checking procedure, discussed in detail below. According to the disclosed embodiments, various protective declarations are used to block other transactions from modifying the contents of the data-cells when it is determined by the epsilon checking procedure that a transaction may commit early. Additional disclosed embodiments include techniques for efficiently handling conflicts and deadlocks between transactions. As a result, significantly fewer transactions are aborted in comparison to a known implementation of an optimistic concurrency control protocol, thereby improving the overall performance of the databases. Further, significantly more transactions can be executed and committed in parallel than with a known implementation of an optimistic concurrency control protocol. Thus, the disclosed embodiments allow for higher parallelism in the transaction working phase, execution, and validation phases.

As such, the disclosed techniques allow for the fast execution of transactions and the processing of more transactions at a given time period. Therefore, the disclosed embodiments provide a technical improvement over current database systems that, in most cases, fail to serve applications that require fast and parallel execution of transactions for retrieval and modification of datasets. The disclosed embodiments can be implemented in database systems as well as in data management systems, such as an object storage system, a key-value storage system, a file-system, and the like.

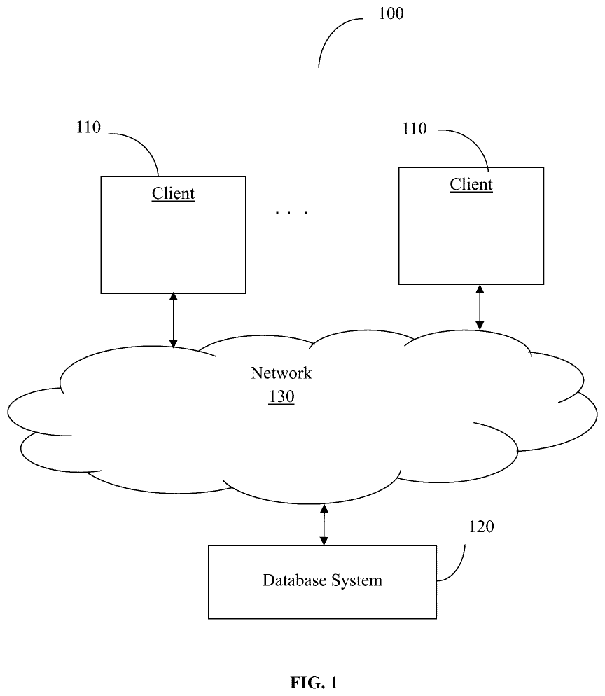

FIG. 1 shows an example network diagram 100 of a distributed computing environment utilized to describe the various disclosed embodiments. In the example network diagram 100, a plurality of clients 110 and a database system (or simply database) 120 are connected to a network 130. Database 120 can be either a distributed or non-distributed database. The network 130 may be, but is not limited to, wireless, cellular, or wired network, a local area network (LAN), a wide area network (WAN), a metro area network (MAN), the Internet, the worldwide web (WWW), similar networks, and any combination thereof.

Each client 110 is configured to access the database 120 through the execution of transactions. A client 110 may include any computing device executing applications, services, processes, and so on. A client 110 can run a virtual instance (e.g., a virtual machine, a software container, and the like).

In some configurations, clients 110 may be software entities that interact with the database 120. Clients 110 are typically located in compute nodes that are separate from the database 120 and communicate with the database 120 via an interconnect or over a network. In some configurations, an instance of a client 110 can reside in a node is part of the database 120.

The database 120 may be designed according to a shared-nothing or a shared-everything architecture. The transactions to the database 120 are processed without locks placed on data entries in the database 120. This allows for fast processing retrieval and modifications of data sets.

A transaction is issued by a client 110, processed by the database 120, and the results are returned to the client 110. A transaction typically includes the execution of various data-related operations over the database system 120. These operations are often originated by clients 110. The execution of such operations may be short or lengthier. In many cases, operations are independent and unaware of each other's progress.

A transaction can be viewed as an algorithmic program logic that potentially involves reading and writing various data-cells. A transaction, for example, may read some data-cells through one data operation, and then, based on the values read, can decide to modify other data-cells. That is, a transaction is not just an “I/O operation” but is more of a “true” computer program. A data cell is one cell of data. Data cells may be organized and stored in various formats and ways. Data cells, defined below, may be contained in files or other containers, and can represent different types (integer, string, and so on).

An execution of a transaction may be shared between a client and the database 120. For instance, in an SQL-based relational database, a client 110 interacts with the database using SQL statements. A client 110 can begin a transaction by submitting a SQL statement. That SQL statement is executed by the database 120. Depending on the exact SQL statement, the database 120 performs various read and/or write operations as well as invokes algorithmic program logic typically to determine which (and whether) data-cells are read and/or written. Once that SQL statement completes, the transaction is generally still in progress. The client 110 receives the response for that SQL statement and potentially executes some algorithmic program logic (inside the client node) that may be based on the results of the previous SQL commands, and as a result of that additional program logic, may submit an additional SQL statement and so on and so forth. At a certain point, and once the client 110 receives an SQL statement response, the client can instruct the database 120 to commit the transaction.

It should be noted that a client 110 can submit a transaction as a whole to the database 120, and/or submit multiple statements for the same transaction together, and/or submit a statement to database 120 with an indication for the database to commit after database 120 completes the execution of that statement.

It should be further noted that transactions may be abortable by the database 120 and/or a client 110. Often, aborting a transaction clears any of the transaction's activities.

For the sake of simplicity and ease of description, the following description would refer to a transaction initiated and committed by a client, and statements of the transaction are performed by the database 120. A transaction may include one or more statements. A statement may include, for example, an SQL statement. One of the statements may include a request to commit the transaction. In order to execute such a statement, the database may break the statement execution into one or more tasks, where each such task is running on a node. With this modeling, a task does not execute on more than a single node, but multiple tasks of the same statement can execute on the same node if needed. A task is an algorithmic process that may require the execution of read operation(s) and/or write operations(s) on data cells.

As defined herein without any limitation, a “writing-transaction” refers to a transaction that writes data-cells. A writing-transaction may also read data-cells. Note that any write-only transaction is also a writing-transaction, but the opposite is not correct. “Reading-transaction” refers to a transaction that reads data-cells. A reading-transaction can also write data-cells. It should be noted that any read-only transaction is also a reading-transaction, but the opposite is not correct. A validating-transaction is a transaction being validated.

As part of its execution, a statement may evaluate one or more predicates. A predicate is a conditional (i.e., Boolean) expression that returns TRUE or FALSE. Predicates are commonly used in statements sent to databases and are often an inherent part of the database statement syntax or language. For example, a common usage of predicates would be to conditionally modify a data-cell(s) based on a condition (predicate) that is based on data-cell(s).

As an example, consider the following data-cells: john_hair_color. john_profession, john_salary, john_start_date; and the following a statement:

```
IF ((john_profession = software_engineer) AND (john_start_date <
1.1.2010))
THEN
  john_salary = john_salary *1.10
  john_profession = senior_software_engineer
```

The predicate is the IF expression and can return TRUE if john is both a software engineer AND started to work earlier than 2010, or FALSE, otherwise. The conditional actions are setting john_profession to a senior software engineer and raising his salary by 10%.

A statement evaluating predicates may consider the value of “Predicate Data-Cells” which are data-cells that were used to calculate the predicate. In the above example, those are john_profession and john_start_date. Another way to term this would be that the predicate is evaluating a single Data-Cell Set, where that data-cell set is (john_profession, john_start_date).

In databases, a statement can be executed on a single, specific row, where that statement involves a predicate (or multiple predicates), where each predicate evaluates a single data-cell set that is often associated with that row.

In addition, in relational databases, as well as in some non-relational databases, it is also possible to perform a statement on a set of rows where the specific identity of the rows is not explicitly known. Instead, the rows are selected according to various criteria and are often selected by a predicate.

For example, in a relational database with an employee table (a row represents each employee), the following SQL statement is performed: “For all the employees that have a profession of software_engineer and started to work in the company earlier than 2010, modify their profession to senior_software_engineer and raise their salary by 10%”. It should be noted that the SQL statements provided herein are not in their proper SQL syntax.

In that case, the scope of the statement is the entire table, and so is the scope of the predicate. While the predicate data-cells are actually the entire profession and start_date columns (i.e., all the corresponding cells for all the rows in the table), the predicate operates, each time, on a separate data-cell set. Such a data-cell set would be, for example, the cells: John's profession and John's start_date. The predicate will also operate on Betty's profession and Betty's start_date (yet another relevant data-cell set). However, inherently, according to the statement semantics, the predicate will not operate on John's profession together with Betty's start_date.

A transaction may be executed over the database 120 in three phases: working, validation, and commit. In some configurations, a transaction may be executed over the database 120 in two phases: working and commit. The embodiments carried by the disclosed concurrency control protocol in each phase are discussed in great detail below.

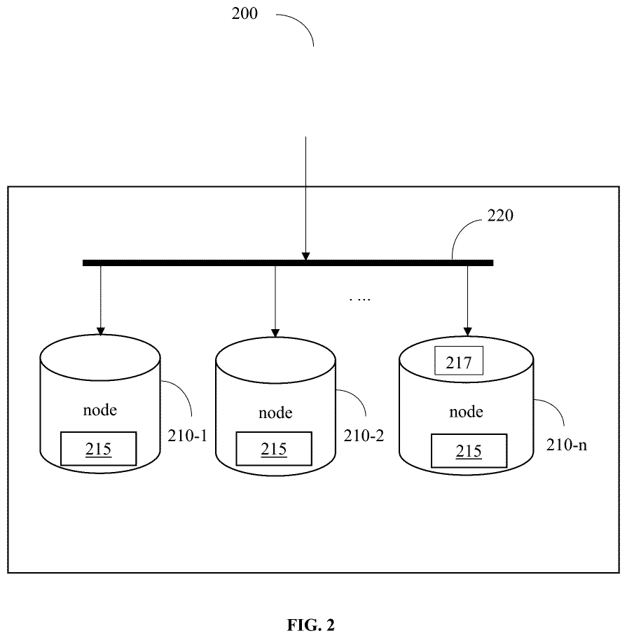

In an embodiment, the database 120 is a distributed database and may be realized as a relational database management system (RDBMS) or a non-relational database. As will be demonstrated in FIG. 2 below, a distributed database is a configuration of multiple computers (hereinafter nodes) that may be situated in the same physical location or in multiple locations. Such locations are typically not geographically distributed. The distribution arrangement of the database 120 requires the execution of transactions and their operations on different nodes independent of each other. Typically, a node is a computer, however, it can also be a virtual server, a user-mode process, a combination thereof, and the like.

In another embodiment, the database 120 is a non-distributed database and may be realized as a relational database management system (RDBMS) or a non-relational database. A non-distributed database is a configuration of one node that may be situated in one physical location. Also, in a non-distributed database, a node is generally a computer. However, it can also be a virtual server, a user-mode process, a combination thereof, or the like.

FIG. 2 shows an example diagram of database 120 arranged according to an embodiment. The database 120 includes a plurality of nodes 210-1 through 210-n, which are distributed. In some configurations, the database 120 operates with one node as a non-distributed arrangement. Each node 210 may be realized as a physical device or a virtual instance executed on a physical device. A virtual device may include a virtual machine, a software container, a service, and the like. The physical device, an example of which is disclosed below, includes at least a processing circuitry and a memory. A physical device may also include a storage, a shared storage accessed by other nodes 210, or a combination thereof. The storage may be realized as magnetic storage, optical storage, and the like, and may be realized, for example, as flash memory or other memory technology or any other medium that can be used to store the desired information. The storage stores the data maintained by the database 120. Nodes 210 may be deployed in one or more data centers, cloud computing platforms, and the like. The communication and synchronization among the nodes 210 is performed through an interconnect network 220.

In one embodiment, the nodes 210, and hence the database 120 are designed with a shared-nothing architecture. In such an architecture, nodes 210 are independent and self-sufficient as they have their own disk space and memory. As such, in the database 120, the data is split into smaller sets distributed across the nodes 210. In another embodiment, the nodes 210, and hence the database 120 are designed with a shared-everything architecture where the storage is shared among all nodes 210.

The data managed by the database can be viewed as a set of data-cells. While the most natural form of those data-cells would be items, such as what relational databases refer to as “column cells”, those data-cells can actually be any type of data, data-object, file, and the like.

Databases often organize a higher level of a data object referred to as data-row (or simply row). A data-row may include a collection of specific data-cells. For example, in relational databases, a set of rows form a database table. The data-cells contained by a specific row are often related to one “entity” that the row describes. In relational databases, the concept of a data-row is inherent to the data-model (i.e., one of the foundations of the relational data-model is processing “data tuples” that are effectively data-rows). Often, data-cells can be added or removed only as part of their data-row. In other words, a data-row can be added (or removed), thus adding more (or removing existing) data-cells to the database.

Typically, all the data-cells of a specific row reside in close proximity (e.g., consecutively) on the storage device, as this can ensure that multiple cells of the same row (or all the cells of the row) can be read from the disk more cheaply (e.g., with a single small disk I/O) than if those cells would each be stored elsewhere on the disk (e.g., with n disk I/Os to n different disk locations in order to retrieve n cells of the same row). Further, the metadata for managing the data-cell information may also be organized in a rougher resolution as it may result in meaningfully lesser and smaller overall metadata.

In some embodiments, a specific data-row can be viewed as if it exists and just contains a single specific data-cell. In one configuration, and without limiting the scope of the disclosed embodiments, a single cell, and a single row may reside in a specific storage device of a node 210. However, it should be noted that a row can be divided across multiple nodes. It should be further noted that the disclosed embodiments can be adapted to operate in databases where data cells are stored and arranged in different structures. In some embodiments, where a row is divided across multiple nodes, the “sub row” that is stored under a single node and/or storage device could be treated as a data-row.

In another embodiment, and without limiting the scope of the disclosed embodiments, the database may also store various pieces of data, in addition to the data-cells and data-rows, including, but not limited to, any and all metadata, various data structures, configuration information, a combination thereof, and the like (hereinafter “metadata”). Additionally, in an embodiment, and without limiting the scope of the disclosed embodiments, the database may also store index information that may be used, for example, for faster searching of data-rows.

In one configuration, the database 120 may maintain at least one index-node and at least one table-node. An index-node is a node (e.g. node 210-1) in which an index, or a part of an index, is stored. A table-node is a node (210-n) in which at least one data-row of a data table is stored. An index-node may also be a table-node, e.g., an index of a data table and data-rows of a data table may reside on the same node. However, validation in an index-node (hereinafter, also denoted as “index-validation”) is a separate process from validation in a table-node (hereinafter, also denoted as “data-validation”). Additionally, the table-nodes and index-nodes may contain data-rows of other tables or may contain other indexes, associated with the same table or with different tables. In some configurations, a node may include an index and data (data-rows).

For simplicity and clarity purposes, index-nodes and table-nodes may be referred to with unique names based on the context of the various disclosed embodiments, e.g., profession index-nodes are all the index-nodes that store a profession index (e.g., of an employee table), and employee-table table-nodes are all the table-nodes that store rows of an employee-table. In the various disclosed embodiments, using indexes allows for faster processing of transactions, e.g., for faster searching of data-rows.

An index is defined as a data structure that maps index values to data-rows of a certain data table. In an embodiment, an index maps an index value to a row ID or equivalent row pointer. In the various embodiments disclosed herein, it is assumed that an index value maps to a row ID unless stated otherwise. In one configuration, an index may correspond to a data column in a data table, e.g., profession, salary, hair color, etc. For example, in a profession index of an employee table, the profession index maps each profession that currently exists for at least one of the existing employees in the employee table, to the row (employee), or rows (employees) that have that profession. For example, a profession index value may be a software engineer. In this case, the profession index may be used for searching all employee table rows having a given profession value, or set of profession values. The index value of software engineer maps to all the row IDs in the employee table where the profession is a software engineer. When a data-cell is written, the index that corresponds to the column of the written data-cell, if such an index exists, is updated accordingly.

In an embodiment, an index may be a unique index. A unique index ensures that the indexed column contain only distinct values, e.g., no two rows can have the same value in that column. In another embodiment, an index may be a non-unique index. A non-unique index allows for duplicate values in the indexed column.

In one configuration, indexes are implemented using persistent B+trees. In another configuration, indexes are implemented using persistent hash-tables. According to the various disclosed embodiments, indexes are assumed to be implemented as persistent B+trees unless stated otherwise.

In a distributed database, an index may be distributed or non-distributed. A non-distributed index means that the index is stored entirely on only one index-node, and covers all the rows that are stored in the pertinent table, where the table's rows may be stored in that index-node, in another node, or distributed across multiple nodes. A distributed index means that the index spans multiple index-nodes, that is, its content is divided and stored on multiple index-nodes. For example, the profession index may be implemented as a distributed B+Tree, distributed across index-nodes N30, N31 and N32, where index information for some professions is stored in node N30, some in node N31 and some in node N32. Such a B+Tree would normally be ordered by profession (e.g., ordered by the profession ID which is, for example, a numerical value). Different indexes (whether distributed indexes or non-distributed indexes) that index columns of the same table are separate entities and can be distributed on different index-nodes. Although an index and a data-row of a data table may reside on the same node, an index value in that index for a particular row ID is not necessarily stored on the same node as the particular row ID is stored.

In some embodiments, an operation of a task may access a single data cell in a single node 210. Furthermore, multiple operations (of the same or different transactions) may access the same data cells simultaneously or substantially at the same time. There is no synchronization when such operations, tasks, or statements of a transaction or transactions are performed. In a typical computing environment, hundreds of concurrent transactions can access the database 120. As such, maintaining and controlling the consistency of transactions and their operations is a critical issue to resolve in databases.

In an embodiment, each node 210 includes an agent 215 configured to manage access to data stored on the respective node. It should be noted that an agent 215 can operate in an index-node or a table-node. In an index node, agent 215 may perform operations related to inserting, deleting, or updating an index-entry of an index residing in the respective node. The agent 215 may be realized in hardware, software, firmware, or combination thereof. Software shall be construed broadly to mean any type of instructions, whether referred to as software, firmware, middleware, microcode, hardware description language, or otherwise. Instructions may include code (e.g., in source code format, binary code format, executable code format, or any other suitable format of code).

The agent 215 is configured to manage the contents of data cells and operations within a node. For example, when a write operation requires access to data cell(s), the agent 215 may be configured to point to the requested cell(s). In an embodiment, each transaction is managed by a transaction manager 217. A transaction manager 217 is an instance executed over one of the nodes 210 and configured to orchestrate the execution of a transaction across one or more nodes 210. The transaction manager 217 may be instantiated on any node 210. In the example shown in FIG. 2, the node 210 the transaction manager 217 runs on the node 210-n.

It should be noted that a transaction manager 217 can reside in any node, including a node that is an index-node or node that is a table-node. It should be further noted that the transaction managers 217 and agents 215 are logical entities that may reside on different nodes, and allow to manage execution of transactions across multiple nodes.

The transaction manager 217 can be realized as a software object, a script, and the like executed over the hardware of a respective node 210. It should be noted that multiple transaction managers may be executed on one node or multiple nodes, where each transaction manager handles a single transaction.

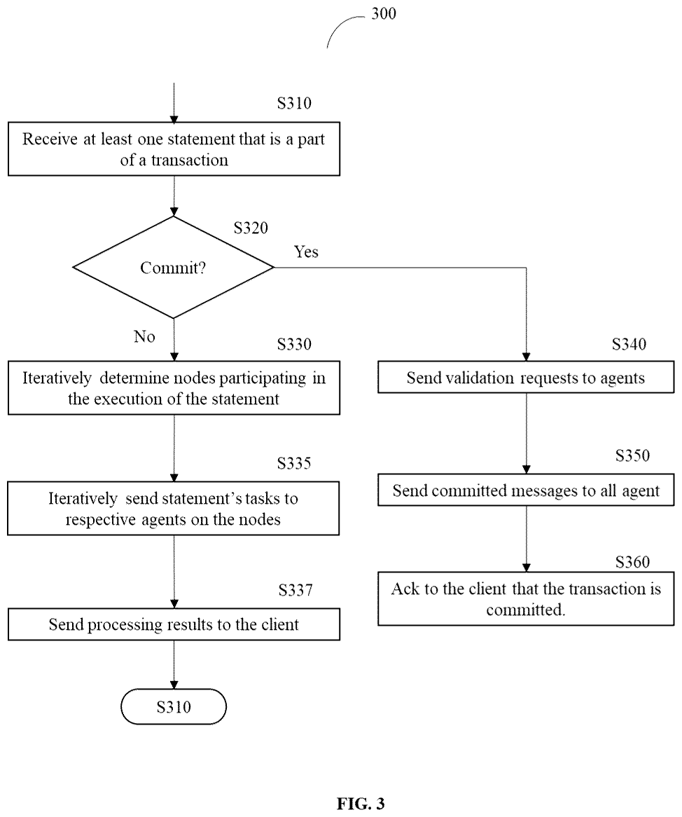

FIG. 3 shows an example flowchart 300 of a concurrency control protocol (CCP) executing transactions in the database 120. The method can be performed by a transaction manager instantiated on one of the nodes, such nodes as 210, FIG. 2.

At S310, at least one statement that is part of a transaction initiated by a client is received. A transaction may include a collection of statements, each of which may include a collection of tasks. A task may require the execution of read operation(s), write operation(s), or both. A task may be a program or logic typically executed by an agent. A read operation requires reading data from a data cell and/or may involve reading/searching in an index, while a write operation requires writing data to a data cell and/or may involve updating indexes. A statement may include a commit statement, thereby committing the transaction.

At S320, it is checked if a received statement is a commit statement, and if so execution continues with S340; otherwise, execution continues with S330.

At S330, nodes (210, FIG. 2) participating in the execution of tasks associated with the received statements are determined. There are different techniques to determine such nodes. For example, a node can be determined based on an index pointing to where data cells to be accessed are located. The techniques to determine nodes of such that are outside of the scope of the disclosed embodiments.

At S335, the tasks are sent to determined nodes. Such nodes process the tasks that are part of a received statement. In an embodiment, a list of the determined agents participating in the working phase of the statement is maintained. Further, for each such agent, it is determined if the agent performs at least one write operation, either to a data-cell or to an index, during the entire execution of a transaction. The execution of such operations by an agent (215) during a working phase is discussed in greater detail below. It should be noted that S330 and S335 may be performed iteratively as part of the execution of one task, when it is determined that another task is required. It should be further noted S330 and S335 may be performed in parallel or, at certain times, at a different order. If the database system is configured as a non-distributed database. S330 and S335 are performed on the same node.

At S337, at the end of the execution of all tasks associated with the received statement, a response is sent back to the client with the results of the processing of the statement. Then, execution returns to S310.

Execution reaches S340, when a commit statement is received from the client. At this stage, a validation request is sent to every agent that performed a write operation for and during the execution of the received transaction. It should be noted that if no write operation has been performed by the transaction, there is no validation request, and execution continues with S350. In the CCP, each agent performing a validation will take a commit pause at the end of the validation process. The commit pause is taken to enable the atomicity of the distributed transaction commitment, by preventing race conditions between the committing transaction that completed its validation and other transactions that may then attempt to read data-cells that were modified by the committing transaction.

As mentioned above, each agent performing a validation performed a write operation for the transaction. In one embodiment, the agent performed (for that transaction) data-cell writes to table data-rows and did not write to an index. Such an agent performs data-validation. In another embodiment, the agent performed (for that transaction) writes to index(es) and did not write to data-cells of table data-rows. Such an agent performs index-validation. In yet another embodiment, the agent performed (for that transaction) both data-cell writes and index writes. Such an agent performs both data-validation and index-validation. In an embodiment, when an agent performs both data-validation and index-validation, then those validations could be viewed as independent processes, where each such a validation process (either data-validation or index-validation) ends with the agent taking commit pause for the relevant data cells/index-entries, and with a submission of a validation confirmation message to the transaction manager. That is, in such a case, the transaction manager should determine that the agent completed its validation only after receiving validation confirmation messages for both the data-validation and the index-validation. In an embodiment, those validation confirmation messages may be unified by the agent to a single validation confirmation message. This is discussed further hereinbelow.

In some embodiments, agents can perform additional activities in a response to the committed message sent at S350. Such activities may include cleanups, removal of protective declarations, and the like. The cleanup activities can be performed independently in a table-node and an index-node by the respective agents. That is, for example, if an agent performs both table-node and index-node operations (or tasks) for transaction TR50, then, upon the reception of committed message for TR50 sent at S350, that agent performs both table-node and index-node activities.

At S350, upon receiving validation confirmation messages from agents (or an agent in a non-distributed configuration) that performed write operations, committed messages are sent to all agents that participated in the execution of the transactions. It should be noted that the committed messages are sent to all agents participating in the execution of the statement regardless of if such agents performed write operations, or not. A committed message indicates to the agent to commit the operations performed, perform various cleanups, and to release the commit pause taken during the validation phase. At S360, an acknowledgment is sent to the client that the transaction is committed. It should be noted that S350 and S360 can be performed in parallel or in a different order.

As can be understood from the above description, the operation of a transaction manager carries through three phases: working, validation, and commit. In the working phase, one or more statements of a transaction are processed. In the validation phase, all data cells that have been written through the transaction are validated. In the commit phase, the entire transaction is committed.

The method discussed with reference to FIG. 3 provides CCP implemented into a database system (or simply a database). Consistency of transactions, by means of the disclosed protocol, is achieved through isolating transactions and adopting different approaches during the execution phases of a transaction. Here, an optimistic approach is implemented during the working phase of a transaction to allow the operation of multiple transactions to run independently without blocking or locks. For validation of a transaction, a pessimistic approach is taken, where a transaction may wait for other transaction(s) to commit. As a result, fewer transactions are aborted in comparison to a known implementation of an optimistic concurrency control protocol, thereby improving the overall performance of the databases. The detailed operation of the CCP as discussed in FIG. 3 includes the working-phase, validation-phase, and commit-phase are described in greater detail in the above-referenced application Ser. No. 18/341,279.

The disclosed embodiments provide a predictive CCP, which allows, in some cases, the early commit of validating transactions. That is, in some cases, a validating writing transaction TR1 may progress to commitment even when it modified a data-cell, or multiple data-cells that were read by a reading transaction TR101 that has not yet committed.

According to the disclosed embodiments, same as the CCP discussed in FIG. 3, the working phase of the predictive CCP is non-blocking. This is advantageous as locking mechanisms tend to result in slower speeds, greater expenses, and greater complexity.

In general, optimistic CCP approaches are non-blocking, but tend to abort transactions upon the detection of conflicts, and usually require the detection of read/write, write/write, and write/read conflicts. As opposed to conventional optimistic CCP approaches, the disclosed embodiments are more tolerant, as the predictive CCP requires only the detection of read/write conflicts. Further, the predictive CCP allows, under some cases, ignoring read/write conflicts that cannot be ignored by conventional optimistic CCP approaches.

Furthermore, according to the disclosed predictive CCP, even if the read/write conflict cannot be ignored, transactions that participate in such a conflict will generally not abort. Instead, in the disclosed protocol, dependencies among such transactions will alter the order of commitments. Any such blocking during the validation phase is done only after the validating transaction has already completed its working-phase and thereby released the resources that were required for its execution. In that respect, such a blocking would use meaningfully fewer resources than a blocking by a conventional CCP. Furthermore, in distributed database environments, the realization of these dependencies is generally simple and consumes minimal resources.

It should be noted that, as would also apply to conventional pessimistic and optimistic CCPs, the predictive CCP is not immune from inter-transaction deadlocks. In the case where an inter-transaction deadlock is detected, one transaction out of the deadlock cycle would be aborted. Techniques for handling deadlocks, including deadlock detection and deadlock prevention techniques, are beyond the scope of the present disclosure.

It should be further noted that the disclosed predictive CCP allows for the performance of a higher degree of parallelism in transactions execution relative to pessimistic solutions while maintaining the same state of the database at the end of processing such transactions as if the transactions were executed in serial. This allows for the fast execution of transactions and the processing of more transactions at a given time period. Therefore, the disclosed embodiments provide a technical improvement over current database systems that, in most cases, fail to serve applications that require fast and parallel execution of transactions for retrieval and modification of datasets. The disclosed predictive CCP can be implemented in database systems as well as in data management systems, such as an object storage system, a key-value storage system, a file-system, and the like.

As briefly mentioned above, in the predictive CCP, in some cases, a validating writing-transaction (i.e., a transaction that is in a validation-phase), hereby referred to as TR1, that has modified a data-cell (or a set of data-cells) previously read by an existing reading-transaction, hereby referred to as TR101, may be enabled to commit even prior to the completion of TR101, while maintaining serializability and other expected consistency properties. This enablement improves the concurrency of the transaction execution. In contrast, it should be noted that in some CCPs disclosed in the related art, transaction TR1 would always be dependent on TR101's completion and would not be able to commit prior to the completion of TR101.

It should be noted that the above-mentioned cases that allow such an earlier commitment have to do with cases where TR101 evaluated a predicate as part of its execution. As mentioned above, a predicate, as discussed in the related art, may be defined as a part of a transaction statement within a database that describes a condition upon which an action may commence. As a non-limiting example, a transaction enacted on a single row in a database may be colloquially described as the following directive: “If John's profession is a software engineer and John's start date is before Jan. 1, 2010, then increase John's salary by ten percent and update John's profession to senior software engineer.” For such a transaction, the predicates are the variables included in the “if” clause, namely “John's profession” and “John's start date”. In contrast, the actions are the steps taken in the “then” clause, namely the increase in John's salary and the update to John's profession.

It should be noted that, as previously discussed, predicates can also be used as part of a statement that selects one or multiple rows that satisfy a predicate. For example, in such a statement where the predicate data-cells are “profession” and “start date”, the predicate data-cell set may comprise “[Jane's profession, Jane's start_date]”, “[John's profession, John's start_date]”, and so on.

In an embodiment, TR101 may have read a relevant data-cell set as part of a predicate evaluation, where, after the predicate returned TRUE or FALSE, the actual concrete contents of the read data-cells that were used for the predicate evaluation are not further used by TR101. In such cases, if TR1 modifies one or more of those predicate data-cells in a way that will not affect the result of the predicate, then, with some further conditions fulfilled, TR1 may consider itself not dependent on that specific TR101's predicate evaluation (and its associated reads). In this specific example, if no other dependencies of TR1 on TR101 are detected, TR1 may commit before TR101's commitment, i.e., TR1 is not dependent on TR101.

It should be noted that the improvement in commitment efficiency described above can be meaningfully beneficial. For example, in relational databases as well as other databases, there are direct ways to access specific cells of specific rows (e.g., by specifying a row ID, a primary index, etc.). However, there are (for example) SQL statements with a broader scope where such a statement acts upon a set of row(s) that are selected by evaluating a predicate. The table rows that satisfy the predicate are the ones that are affected by the statement. The predicate evaluation is either done by a full (data) scan, by index searches or by a combination of index searches and data scans.

From a general serializable CCP perspective (i.e., without the mechanisms described by this disclosure), such a predicate-based search (e.g., performed by TR101) is generally analogous to reading all the predicate data-cells of all the rows in the table (e.g., of the entire columns related to the predicate), even if only some or even very few of the rows answer the predicate and are actually used by TR101. That may meaningfully limit the concurrency in transaction execution, as it may create many conflicts with other transactions. For example, a writing transaction TR1 that modified pertinent data-cells in a couple of rows that were not selected by TR101 may, in many cases, be blocked due to TR101, despite the fact TR101 did not select these couple of rows. Therefore, the disclosed embodiments provide mechanisms that minimize such dependencies whenever possible.

In an embodiment, and for brevity and clarity, the following notation may be used: ‘TRx-AGnn’ is the transaction agent that is instantiated on node ‘nn’, in the context of operation(s) that that specific transaction agent performs on behalf of transaction ‘TRx’. For example, TR1-AG30 may refer to the transaction agent instantiated on node 30, in the context of operations it performs for transaction TR1. This disclosure may refer to such an entity as ‘the transaction agent of TR1 in node N30’. It should be noted that TR1-AG30 and TR2-AG30 may be referred to as ‘the transaction agent of TR1 in node N30’ and ‘the transaction agent of TR2 in node N30’, respectively, where both refer to the same transaction agent 215 instantiated on node N30 (but in the context of the specific operations it performed on behalf of the said transaction). It should also be noted that the term ‘agent’ and ‘transaction agent’ are used herein interchangeably.

Regardless of whether an index is distributed or non-distributed, an index is used, in databases, for searching for rows that answer a specific criterion. As such, indexes can be used to locate the rows answering a predicate evaluation, and/or to narrow down the number of rows that are required to be further scanned as part of a predicate evaluation. The values that are searched in an index as part of a predicate evaluation hereinafter may be referred to as index search-values or search-values. A search-value could be one value, a set of values, a range of values, or a combination thereof.

For each search-value that TR101 will search for a given index in an index-node, a conditional index read-vector entry (IRV-entry) is added by TR101's agent in TR101's index read-vector (IRV) of that index-node. The IRV-entry describes the corresponding search-value(s). In an embodiment, the conditional IRV-entry additionally designates and describes the full predicate that caused TR101 to access that index-node as part of the search. In another embodiment, in addition to the corresponding search-value(s), the conditional IRV-entry may store a unique identifier that TR1's agent can use to retrieve the content of the full predicate from another node.

In one embodiment, an entire predicate evaluation is performed by accessing a single index. For example, for an employee-table for which a profession-index exists, a predicate evaluation is performed searching for all software engineers and software architects, by using the profession-index. In this case, the profession index is searched for all software engineers. The result of this search is all of the row IDs that are mapped by the profession index for software engineers. That is, the row IDs of all the employees whose profession is software engineer. The profession index is also searched for all software architects. The result of this search is all of the row IDs that are mapped by the profession index for software architects. Each resulting row exists once. The list of the resulting row IDs for the software engineer index search and the list of the resulting row IDs for the software architect index search are unified. The unified list is the scope of the entire predicate evaluation. That is, it contains all the rows that satisfy the corresponding predicate.

In another embodiment, a predicate evaluation is performed by accessing a single index and by further scanning of data-rows. A profession index exists for the employee-table, but no hair-color index exists. In this case, a predicate evaluation is performed for all software engineers and software architects that have a red/orange hair-color. First, the profession index is searched for all software engineers and all software architects. A list of all the resulting row-IDs is created (as explained above). Then, a scan is performed in the employee table, on the row-IDs from the list. That is, information from the table's data-rows represented by the row-ID list is read. The hair-color for each such table's data-row is read. The results are further narrowed to those data-rows where hair-color is red/orange. The approach in this embodiment allows for faster query processing because the scanned data-rows are only the software engineer and software architect rows identified by the index search, as opposed to the entire table, which may be much larger.

In another embodiment, a predicate evaluation is performed by accessing multiple indexes. For a given employee-table, a profession index exists, and a hair-color index exists. In this case, a predicate evaluation is performed for all software engineers and software architects that have a red/orange hair-color. First, the profession index is searched for all software engineers and all software architects. The lists of row-IDs that result from the two profession-index searches are unified (as explained above). Next, the hair-color index is searched for red hair-color and orange hair-color. The lists of the row-IDs that result from the two hair-color index searches are unified (as explained above). The two unified lists (i.e., the row ID list containing the rows with a software-engineer/software-architect profession and the row ID list containing the rows with the red/orange hair-color) are then intersected so that the resulting intersected row-ID list is of the rows that satisfy the predicate. Additionally, in a further embodiment, the above approach can also combine further narrowing by scanning data-rows for another part in a predicate that is not based on indexed columns (as explained above). For example, a predicate that searches for all software-architects/software-engineers that have a red/orange hair-color whose height is 180 cm, where indexes exist for the profession and the hair-color columns and an index does not exist for the height column.

Even if a particular index exists for a column that is part of a predicate, in a way that the index could be relevant for that predicate evaluation, a database's query planner or query optimizer may choose to forgo a search of that particular index and scan the relevant data-rows directly. In some embodiments, such an approach may result in more efficient computation and in fewer input/output operations.

In an embodiment, a query planner may completely avoid performing an index search for a specific predicate evaluation, even if relevant indexes exist. For example, a predicate evaluation requires a search for all brown-hair employees in an employee table, where, for instance, 70% of employees in that table have brown hair. In this example, a hair-color index exists for the employee table. In this case, a query planner may decide that performing a full-scan of the table would require fewer input/output operations than searching a hair-color index, and hence may decide to avoid performing index searches for that predicate's evaluation.

However, in an alternative embodiment, a query planner may only avoid performing an index search on some but not all of the indexes. For example, a predicate evaluation requires a search for all employees with a profession of a fortune teller with brown hair in an employee table, where, for instance, 5% or fewer employees are fortune tellers. A query planner may choose to search the profession index for fortune tellers and scan the resulting row IDs of those fortune tellers, in the employee-table, narrowing down to only those who have brown hair. Under such conditions, such an approach may be more efficient than incorporating a hair-color index search for those who have brown hair.

An index is not organized by rows but rather by values. If a row is updated, the relevant index(es) is/are also updated. However, there may not be a relevant index that needs updating. For example, if an employee table includes Jane, and the data-cell for Jane's hair-color is updated, no update to the profession index is required because the data-cell for Jane's profession has not been updated. If, however, the data-cell for Jane's profession was updated, and the data-cell for Jane's hair-color was not updated, then the profession index must be updated but the hair-color index does not need to be updated.

If a new data-row is added for employee John in the employee table, index-entries must be inserted into all the relevant indexes. An index-entry is defined as a record in an index that consists of an index value (whether explicitly or implicitly, depending on the data-structure implementation) and a row ID corresponding to the index value. Similarly, in an embodiment, if John's data-row in the employee table is deleted, all corresponding index-entries of the various indexes of the employee table are removed as well.

In some embodiments, an index value is modified. For example, an operation that changes Jane's profession from dentist to software engineer may require two internal index modification operations. That is, a previous version of the index-entry containing Jane's profession of a dentist is removed (hereafter denoted as “previous version”), and a new version of the index-entry containing Jane's profession of a software engineer is added (hereafter denoted as “next version”). In an embodiment, the next version of the index-entry is added prior to the transaction commitment (in an “uncommitted” manner), and the previous version of the index-entry is removed only after the transaction committed.

According to some embodiments, handling the operation to modify Jane's profession as two separate internal index modifications is useful in distributed databases. For example, a profession index is stored on index-nodes N30 and N31, where N30 stores the portion of the index that covers the index value of dentists, and where N31 stores the portion of the index that covers the index value of software engineers. In this instance, the modification to Jane's profession requires one index-entry deletion of the previous version of the index-entry in N30 and one index-entry insertion of the new version of the index-entry in N31.

There may be a database that allows multiple transactions that update the same indexed cell to execute simultaneously. For example, Jack's salary is 1,000. Transaction TR1 modifies it to 1,100. A concurrently running transaction TR2 modifies it to 1,200. Both TR1 and TR2 are still running (have not yet committed). Because TR1 and TR2 have not yet been committed, a previous version of an index-entry for Jack's salary is not well-defined. From TR1's perspective, the previous version of the index-entry is unknown because it could be 1,000 if TR1 commits first, or it could be 1,200 if TR2 commits first. The next version of the index-entry, on the other hand, is well-defined from TR1's perspective because it is the value of 1,100 that TR1 writes into the relevant index-node.

For each such index-entry write operation, an index write-vector entry (IWV-entry) is added. For example, TR1's transaction agent in an index-node N30 (TR1-AG30) writes an index-entry, e.g., add or delete an index-entry. So, if TR1-AG30 writes an index-entry in index-node N30, TR1-AG30 will then mark that write in the index write-vector (IWV) in N30 by adding a corresponding IWV-entry. Each such IWV-entry contains details of the written index-entry e.g., the new index value and the row IDs corresponding to the index value, etc. The IWV-entry is added only for the next version of the index entry to be written, e.g., the IWV-entry is stored in the index-node where the next version of the index-entry is stored. As for an index-entry deletion, in some embodiments, the next version of the index-entry is “inexistence.” This may be achieved when there is a need to temporarily maintain the index-entry of the previous version, by adding a “tombstone” index-entry that temporarily marks the deletion. In an embodiment, such a technique may be used, for example, for the realization of removing a row in an uncommitted manner.

According to the disclosed predictive CCP, a transaction agent for transaction TR5 that runs on a table-node N20 (TR5-AG20) uses a read-vector (RV) and/or a write-vector (WV). It should be noted that according to the disclosed embodiments, before or during a working-phase of a transaction (TR5), a read-vector (RV) and a write-vector (WV) are created in each table-node in which TR5 executes. In this example embodiment, a RV and a WV are created in table-node N20 in which TR5-AG20 operates. During a working-phase of the transaction TR5, when TR5-AG20 reads a data-cell that is not for the purpose of a predicate evaluation, TR5-AG20 may add an RV-entry to its RV, designating the data-cell being read, and may then read the most up-to-date committed cell contents. This type of an RV-entry may be denoted as a “non-conditional RV-entry”, and this type of reading may be denoted as a “non-conditional read”. In an embodiment, during a working-phase of TR5, when TR5 evaluates a predicate, TR5-AG20 may add a read-vector entry (RV-entry) to its RV, designating the entire predicate evaluation. This type of an RV-entry may be denoted as a “conditional RV-entry”. A conditional RV-entry contains information describing the predicate that is evaluated. A single conditional RV-entry may represent a predicate evaluation of a single data-cell set or of multiple data-cell sets, where the latter is typical, for example, for cases where the scope of the predicate contains multiple rows or the entire set of rows of a table.

Then, transaction TR5 may perform the predicate evaluation of one or more data-cell sets by reading their most up-to-date committed cell contents. Such data-cell read(s) may be denoted as a “conditional read”. During a working-phase of the transaction TR5, when TR5-AG20 writes a data-cell, it may add a write-vector entry (WV-entry) to its WV, designating the data-cells being written. Additionally, transaction TR5-AG20 may write the data-cell contents in an “uncommitted manner” such that they are “private” and hence inaccessible for reading by any other transaction. Such a data-cell write may not override or change any elements of the currently committed data-cell contents.

According to the disclosed predictive CCP, the data-validation of a validating writing-transaction TR1 detects the non-conditional conflicts as well as the conditional conflicts between TR1 and other reading transactions. As mentioned hereinbefore, the data-validation is performed by TR1's agents that performed data-cell write operations. In an example embodiment, TR1-AG20 performs data-validation for TR1 in node N20. In general, a conflict may be indicated by the presence of cells that were modified by TR1-AG20, and were read by another existing reading transaction, such as TR101-AG20. A non-conditional conflict may be defined as a conflict pertaining to a read operation by the reading-transaction (e.g., by TR101-AG20) that was not performed as part of a predicate evaluation. Such a reading-transaction may be denoted as a “conflicting transaction”. In one example embodiment, such an identification, inside node N20, could include iteratively scanning the WV of the validating TR1-AG20 for data cells that TR1-AG20 wrote to. Further, for each such data cell, all active reading transactions (except for TR1 itself) that non-conditionally read from the cell are identified, in node N20. This can be performed by scanning the reading the transactions' read vectors in N20. The validating-transaction TR1 is marked (in node N20) as dependent on each reading transaction with which TR1 has a non-conditional conflict.

A conditional conflict is defined as a conflict pertaining to a read by the reading-transaction (TR101) that was performed as part of and for the purpose of predicate evaluation of a specific data-cell set. In an embodiment, as part of TR1-AG20's data-validation, all the current conditional conflicts (that are reflected in table-node N20) with the validating transaction are identified. A read that was performed as part of and for the purpose of a predicate evaluation may be denoted as a conditional read and may include the creation of a conditional RV-entry. Such a reading-transaction may also be denoted as a “conflicting transaction”. In an embodiment, a conditional RV-entry represents the entire predicate evaluation. It should be noted that a conditional conflict is in a data-cell set granularity. In an example embodiment, a reading-transaction TR101 evaluates a predicate PR1010 for all the rows in a table. The predicate PR1010 is used to select the rows of people with “red” hair-color and a profession of “software engineer”. In this example, the validating transaction (TR1) modified Jane's hair-color and modified George's hair-color. In this example, there are two conditional conflicts between TR1 and TR101, both for predicate PR1010. That is, one conditional conflict is for the data-cell set [Jane's hair-color, Jane's profession], and the other conditional conflict is for the data-cell set [George's hair-color, George's profession].

As part of the data-validation process, each identified conditional conflict is processed. In an embodiment, each identified conditional conflict may be classified as being of a particular state. A state characterizes a particular relationship between the evaluations of a predicate before and after the commitment of a validating transaction TR1. The process of determining the state of the conditional conflict is discussed further below. As discussed below, the state may include move-in, move-out, stay-in, or stay-out. In an embodiment, the determination of each of the four states requires the execution of the epsilon checking procedure as discussed below.

In general, a move-in state describes the following situation: R5 is the row containing the data-cell set related to the pertinent conditional conflict between reading-transaction TR101 and the validating writing-transaction TR1 related to predicate PR1010 evaluated by TR101; and TR1 is the only currently active transaction that modifies any of the data-cells related to that data-cell set. In the move-in state, without the modifications TR1 applies, the evaluation of PR1010 will not select row R5. In the move-in state, with the modifications TR1 applies, the evaluation of PR1010 will select row R5. Therefore, to satisfy various transactional consistency expectations, an early commit of TR1 may require “moving R5 into” the set of rows selected by TR101. Since TR101's execution may not be able “to see” TR1's modifications, an early commitment of TR1 may violate the transactional consistency expectations and hence may not be allowed.

Similarly, in general, a move-out state describes a situation where, without TR1's modifications, TR101 will select R5, whereas if TR1's modifications were included, TR101 would not select R5. Therefore, similarly, TR1's early commitment may not be allowed.

In general, a stay-in state describes the situation where, under similar conditions as described above, TR101 would select R5, with or without including TR1's modifications. Therefore, it can be viewed as if the early commit of TR1 keeps R5 “stays in” the set of rows selected by TR101.

Similarly, a stay-out state describes the situation where TR101 would not select R5, with or without including TR1's modifications. Therefore, this state can be viewed as if the early commit of TR1 makes R5 “stays out” of the set of rows selected by TR101. Under some conditions, and from the perspective of this specific conditional conflict, TR1 may be allowed to commit earlier than TR101 for both stay-in and stay-out cases. This is discussed in the above-referenced application Ser. No. 18/944,462

In an embodiment, as part of the data-validation process, this evaluation of the conditional conflict may utilize an epsilon checking procedure (based on the epsilon principle explained herein). Given a validating-transaction TR1's agent TR1-AG20 that has a conditional conflict with a reading-transaction TR101 on node N20, the epsilon checking procedure determines whether a state of a conditional conflict is a stay-in, stay-out, move-in, or move-out state.

The epsilon checking procedure relates to two methods of characterizing the moments immediately before and immediately after TR1's commitment. For example, a TR1 modifies the cell contents corresponding to an employee's hair color from “black” to “red”. In the moment immediately before TR1's commitment, the employee's hair color will be “black”. In the moment immediately after TR1's commitment, the employee's hair color will be “red”. The function ε−(TR1) may be denoted to describe the moment immediately prior to the commitment of TR1, while the function ε+(TR1) may be denoted to describe the moment immediately following the commitment of TR1.

In an embodiment, by way of the epsilon checking procedure, an evaluation of a predicate of a transaction may be denoted in relation to a specific timepoint for a specific row. For example, for a predicate PR1010, a function PR1010(x, ε+(TR1)) will return the evaluation of PR1010 for the pertinent data-cell set of row ‘x’ at the moment immediately following the commitment of TR1.

According to an example embodiment, a validating-transaction TR1 is initiated after a reading-transaction TR101 is initiated, but before TR101 is committed. TR101 involves the evaluation of a predicate PR1010 in node N20, and TR1's agent in node N20, TR1-AG20, is validating, as the above-mentioned data-cell modification took place in node N20, by TR-AG20. In this case, the epsilon principle allows for TR1 to commit before the commitment of TR101 if PR1010(x, ε+(TR1))=PR1010(x, ε−(TR1)). That is, if the evaluation of PR1010 at row ‘x’ returns the same values immediately prior to TR1's commitment as immediately following TR1's commitment, TR1 may be allowed to commit before the commitment of TR101. This case may be denoted as an expression that the “epsilon principle is satisfied”. It should be noted that in a plurality of embodiments, there may be more than one predicate that would need to satisfy the epsilon principle in order to allow for TR1 to commit early.

It should be noted that for the PR1010(x, ε−(TR1)) function calculation, the values to be evaluated by the predicate function by TR1-AG20 are those that are currently committed. For the PR1010(x, ε+(TR1)) function calculation, the values to be evaluated by the predicate, for data cells that were not modified by TR1-AG20, are those that are currently committed. In addition, for data cells that were modified by TR1-AG20, the values to be evaluated by the predicate are those written by TR1-AG20.

It should also be noted that an evaluation and satisfaction of the epsilon principle effectively checks for stay-in or stay-out states. If the epsilon principle is not satisfied, this effectively indicates move-in or move-out states. The various states are further discussed in the above-referenced application Ser. No. 18/944,462.

For brevity and clarity, the combination of a predicate (e.g., PR1010) and a data-cell set (e.g., a specific row R5) it evaluates will be notated as “[PR1010*R5]”. It should be noted that a conditional conflict between validating writing-transaction TR1 and reading-transaction TR101 on behalf of predicate PR1010 and row R5 may be denoted as a conditional conflict related to [PR1010*R5]. Additionally, in an embodiment, the predicate evaluates multiple rows of a table. As each data-cell set represents data-cells that belong to the same row, the identity of a row (e.g., row R5) and the corresponding data-cell set evaluated by the predicate (e.g., DCS5) will be used interchangeably to denote the associated data-cell set.

As mentioned hereinbefore, the validating-transaction TR1's agent TR1-AG20 performs the epsilon checking procedure as part its data-validation, and the PR1010(x, ε−(TR1)) and the PR1010(x, ε+(TR1)) calculations are done at a moment during the data-validation process. The data-cell values in use for those calculations should represent their values at the timepoints ε−(TR1) and ε+(TR1), respectively. As mentioned hereinbefore, in an embodiment, the cell values to be evaluated for PR1010(x, ε−(TR1)) are those that are currently committed, and the cell values to be evaluated for PR1010(x, ε+(TR1)) are those that are currently committed, further amended, for data cells that were modified by TR1-AG20, by the values that were written by TR1-AG20. This approach may indeed effectively use the true data-cell values for the timepoints ε−(TR1) and ε+(TR1), respectively. However, this may be subject to a race condition where there is an additional validating-transaction TR2 (or multiple additional such transactions) having an agent TR2-AG20, that modified data-cells that belong to the pertinent data-cell set x of PR1010. The race condition may be described as a condition that allows for one of the transactions, TR1 and TR2, to proceed to validate the corresponding conditional conflict prior to the commitment of the other transaction. For example, in an embodiment, TR1-AG20 performs an epsilon checking procedure for PR1010(x) that is satisfied. Then, TR2-AG20 performs an epsilon checking procedure for PR1010(x) that is satisfied as well. Then, TR2 proceeds to commitment, that is an early commitment vs. the reading-transaction TR101. By TR2's commitment, some of the corresponding data-cells of row x are modified, in a way that would actually cause a later epsilon checking by TR1 not to be satisfied. However, TR1 already performed the epsilon checking procedure and it was satisfied, and then TR1 commits (earlier than TR101). As a result, principles of serializability and consistency may be violated.

To avoid that problem, the disclosed embodiments herein use protective validation techniques.

In some embodiments, if the epsilon principle is satisfied, as part of the data-validation of TR1-AG20, TR1-AG20 creates an active protective declaration that is said to be issued by the validating-transaction TR1, and sourced by the reading-transaction TR101, for the specific predicate of a data-cell set where the epsilon principle is satisfied (e.g., for [PR1010*DCS1]. This activity is performed in node N20. An active protective declaration is a mechanism that prevents other writing transactions that modified the contents of that data-cell set from committing. That is, as long as that active protective declaration exists, no other writing transaction agents in node N20 (e.g., TR2-AG20), if any, that modified any of DCS1's cells, will be able to progress to commitment and/or to evaluate the epsilon principle for [PR1010*DCS1]. Such a declaration functions to ensure the contents of a data cell in which the epsilon principle is satisfied are not modified by another transaction such that the epsilon principle is becoming not satisfied. Generally, a protective declaration is associated with a conditional conflict between a validating writing-transaction TR1 and a reading-transaction TR101. Such a protective declaration is denoted as “issued” by the validating writing-transaction TR1 and is denoted as “sourced” by the reading-transaction TR101. A protective declaration may have inactive states wherein the protective declaration exists for a specific predicate of a data-cell set but does not have the protective effect as described above. Such a state may be changed from inactive to active or active to inactive in various embodiments. The protective validation techniques are described in greater detail in the above-referenced application Ser. No. 18/945,062.

It should be noted that the data-validation activities and cleanup activities are performed by agents in response to validation messages and committed messages. Such activities are discussed in detail in the above-referenced application Ser. No. 18/945,062. Further, the related data-validation and cleanup activities can be performed independently in a table-node and an index-node by the respective agents.

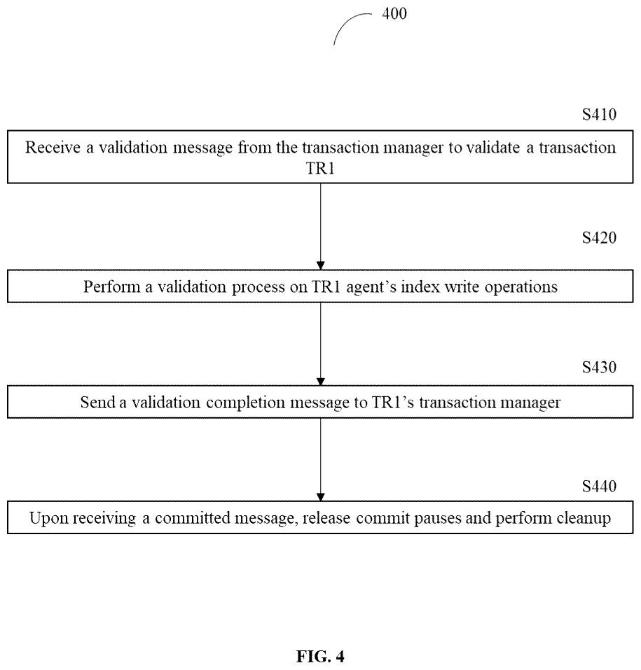

FIG. 4 is a flowchart of an example process 400 illustrating the operation of a validation-phase and commit-phase of a transaction agent in an index-node of the predictive CCP on distributed databases employing index-nodes according to one embodiment. The process 400 can be performed by each of TR1's agents instantiated on the index-nodes, such as nodes 210 in FIG. 2. In an embodiment, the process 400 is employed as part of a sufficient-instantiation technique (discussed in more detail later). In an embodiment, the process 400 is performed by TR1's agent in index-node N30, TR1-AG30. That is, TR1-AG30 performs an index-validation.

It should be noted that TR1-AG30 may also have performed table-node activities. If this is the case, TR1-AG30 may also need to perform data-validation as well as table-node activities after receiving a committed message from the transaction manager. As mentioned hereinbefore, the data-validation as well as other table-node activities may be viewed as an independent process that is discussed elsewhere. For simplicity and brevity, the description herein assumes that TR1-AG30 performs only index-validation and other index-node related activities and that TR1-AG30 need not perform table-node related activities such as data-validation.

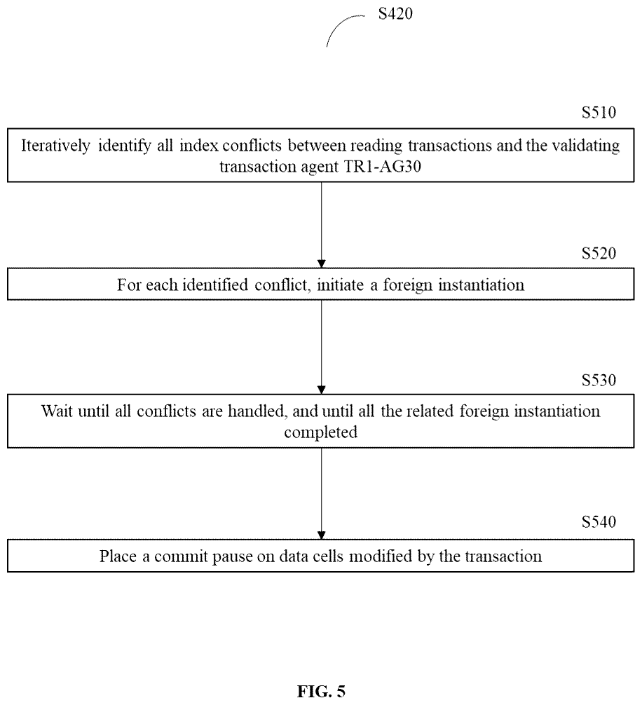

The working-phase and the commit-phase of the predictive CCP can be performed as discussed in reference to FIG. 3. A validation-phase for TR1 may include both an index-validation process (discussed in detail in reference to FIG. 5) and a data-validation process. While the processes are similar, there are a few key differences. In index-validation, conflicts (hereafter also denoted “index-conflicts”) are identified between index write-vectors (IWVs) and index read-vectors (IRVs) on index-nodes. Index-conflicts are related to read and write activities that took place in relevant indexes. In data-validation, conflicts (hereafter also denoted as “data-conflicts”) are identified between write-vectors (WVs) and read-vectors (RVs) on table-nodes. Data-conflicts are related to read and write activities of data-cells as well as related to predicate evaluations. The way data conflicts are classified and handled is different than the way index-conflicts are handled. As mentioned hereinbefore, the related activities in the table-nodes, including data-validation and the protective validation techniques, are disclosed in the above-referenced application Ser. No. 18/945,062. The focus of process 400 is the validation-phase and commit-phase by TR1-AG30 that performs an index-validation and/or other index-related activities on an index-node N30 for transaction TR1.

In an embodiment, the example process 400 described by FIG. 4 is performed when a commit statement is received from the client. At this stage, a validation request is sent to every agent that has performed a write operation. Process 400 is performed by each agent of the validating transaction TR1 that is instantiated in an index-node and performed index-related activities for TR1. The text hereinbelow uses TR1-AG30 as such an agent.

At S410, a validation request is received. In an embodiment, such a request is received by TR1-AG30 in the case TR1-AG30 performed index write operations on behalf of TR1. If TR1-AG30 did not perform an index write operation (for example, if TR1-AG30 only performed index read operations), then process 400 for TR1-AG30 will be initiated at S440, upon receiving a committed message from TR1's transaction manager.

At S420, an index-validation process is performed. In some embodiments, the validation process is performed for all index write operations executed by an agent on behalf of TR1. The various embodiments of S420 are further discussed in FIG. 5.

At S430, a validation completion message is issued. In an embodiment, such a message is issued upon completion of the index-validation process and sent to the transaction manager and issued by TR1-AG30. As noted above, when such messages are issued, commit pauses are taken to allow the transaction (TR1) to commit.

At S440, upon receiving a committed message, commit pauses that TR1-AG30 placed in the context of the index writes are released. Furthermore, when TR1 that wrote to an index commits, the contents of the index writes become “committed”, and, whenever relevant, override previous index information. Additionally, TR1-AG30 may perform various cleanups. For example, in an embodiment, TR1-AG30 removes its IRV and IWV. Additionally, in an embodiment, TR1-AG30 may notify other agents in N30 whose transactions are in index-conflict with TR1 on TR1's commitment. For example, TR2-AG30 may have modified an index-entry that TR1-AG30 read as part of an index search. Those notified agents may then react by cancelling activities that are not required anymore, such as an origination of a related foreign instantiation. This is discussed in detail hereinbelow.

FIG. 5 is an example flowchart S420 describing the operation of an index-validation of the predictive CCP according to one embodiment. In an embodiment, the process S420 can be performed by TR1-AG30. In an embodiment, the index-validation performed by TR1-AG30 is part of a sufficient-instantiation technique (discussed in more detail later).

In one embodiment, the process S420 is performed during the validation-phase of TR1. For example, by the time the validation-phase starts, it may, in some embodiments, be beneficial to start process S420 only at the validation-phase, e.g., since some of the reading transactions may already have completed or have instantiated IRV-entries (e.g., TR101 has agents) in more index-nodes.

In another embodiment, the process S420 is performed during the working-phase of a transaction as long as the index-validation handling completes before TR1 progresses to commitment. For example, because foreign instantiation (described below) is a distributed procedure, beginning the process S420 sooner than the validation-phase e.g., during the working-phase, may, in some embodiments, shorten the overall execution time of TR1.

In an embodiment, a table in a distributed database, e.g., an employee table, is distributed across a plurality of table-nodes, e.g., N20, N21, N22, N23 and N24. An index of the employee table, e.g., a profession index resides in a plurality of index-nodes, e.g., N30 and N31. As mentioned hereinbefore, an index is used, in databases, as means for searching for rows that answer a specific criterion. That is, if a database statement or task, e.g., of reading-transaction TR101, requires a predicate evaluation to search and select a set of rows that answer a specific predicate (PR1010), then relevant indexes may be used. As mentioned hereinbefore, in an embodiment, an index search, or a combination of index searches may result a row ID list (RID101) that constitutes the list of rows that are selected by the entire predicate PR1010. In such a case, TR101, using pertinent agents in the pertinent table-nodes may further access the data-rows appearing in the resulted row ID list RID101, thus reading and performing the related actions on those rows. In another embodiment, the row ID list resulted by the index(es) search RID101 requires further narrowing down that is achieved by accessing and scanning the data-rows appearing in RID101 in the pertinent table-nodes, and checking further whether those rows satisfy the predicate PR1010, using pertinent agents. As part of that narrow-down process, the pertinent agents may act upon the rows that were accessed and that answer the predicate PR1010.

It should be noted that in both of the above cases, given the resulted row ID list RID101, there may be employee-table's table-nodes that do not contain any of the rows in RID101. Such table-nodes may be denoted as “uncovered-nodes”. Each of the other employee-table nodes contain at least one row of RID101. Those nodes may be denoted as “covered-nodes”. In an embodiment, the covered-nodes are N20 and N21, and the uncovered-nodes are N22, N23, and N24. It should be noted that TR101 agents in covered-nodes (TR101-AG20 and TR101-AG21) may be required for further processing the rows in RID101. In contrast, TR101 agents in uncovered-nodes (TR101-AG22, TR101-AG23, and TR101-AG24) may not be required for processing the rows in RID101, as those uncovered-nodes do not contain any such row. If other parts of TR101 execution do not require activities in any of those uncovered-nodes, it may not be required to create those agents at all, possibly resulting in a more efficient execution.

As described hereinbefore, to participate in a predicate evaluation, every agent in a table-node may add a conditional RV-entry describing the predicate PR1010 prior to reading any related data-cells. Such adding of an RV-entry may be denoted as an “instantiation of the RV-entry” in a specific table-node. It should be noted that each such agent may instantiate such a conditional RV-entry in its table-node even in the case where the index searches identify the row ID list RID101 without requiring a further narrowing down. Such an RV-entry instantiation allows the protective validation technique to further inspect whether a writing-transaction TR1 can be enabled for an early commit over TR101 that evaluated one or more predicates that uses data-cells that TR1 modified.

In the examples described above, the covered-nodes are N20 and N21, and there are uncovered-nodes N22, N23 and N24. As such, in an embodiment, the agents TR101-AG20 and TR101-AG21 are created and instantiate the relevant conditional RV-entry for PR1010 in nodes N20 and N21, respectively. However, and as discussed hereinbefore, the agents TR101-AG22, TR101-AG23, and TR101-AG24 are not required. Therefore, the pertinent RV-entry is not instantiated in nodes N22, N23, and N24. A scenario where the existence of uncovered-nodes results in a table-node(s) that contains the pertinent employee-table but in which the pertinent RV-entry is not instantiated may be denoted as “partial-instantiation”. A scenario where the RV-entry is instantiated in all the pertinent table's table-nodes may be denoted as “complete-instantiation”.

In an embodiment, a partial-instantiation scenario for a predicate PR1010 evaluated for reading-transaction TR101, may cause a situation where the protective validation technique may allow a writing transaction TR1 to early-commit over TR101, although such an early-commitment might violate serializability and other consistency expectations. For example, if TR1 creates a move-in situation by writing to a row that resides in an uncovered-node N22, then TR1's data-validation (done by TR1-AG22) may miss the existence of the conditional conflict related to TR101's predicate evaluation because that RV-entry is not instantiated in N22. It should be noted, however, that the inexistence of an RV-entry in an uncovered-node (e.g., N23) in which no writing-transaction modifies data-cells related to the not-instantiated RV-entry will not result in any serializability or consistency violation.

Therefore, the disclosed embodiments describe the sufficient-instantiation-technique. The sufficient-instantiation-technique solves the above problem by ensuring that the pertinent RV-entry will be instantiated in any table-node in which a conditional conflict related to TR101's predicate evaluation of PR1010, with a writing-transaction, may occur. The sufficient-instantiation-technique may still allow partial-instantiation, that is, if there is an uncovered-node N23 in which the inexistence of the pertinent RV-entry will not result in missing conditional conflicts, then the instantiation of the pertinent RV-entry in N23 may not necessarily occur.

In some embodiments, there is a move-in scenario (hereinafter, “original move-in scenario”) for a data-row in an uncovered-node that does not have an RV-entry instantiated for the predicate. TR101 evaluates the predicate PR1010 ((profession=software engineer) AND (salary=1000-1499) AND (height>180 cm)). An employee table includes profession, salary, and height columns. There is a profession index on N30, a salary index on N40, but the height column is not indexed. Transaction TR101 evaluates the predicate with the strategy of performing index searches using the profession index and the salary index, resulting in a row-ID list containing all software engineers with a salary 1000-1499, followed by an additional narrowing down the rows in the row-ID list, using pertinent table scans, in the relevant table-nodes containing those rows, to seek for the rows in the row-ID list whose height data-cell is greater than 180 cm. The employee table is stored on nodes N20, N21, N22, N23 and N24. However, software engineers with a salary 1000-1499 are stored only on N20 and N21. That is, related to the index search part of the predicate PR1010 evaluation, N20 and N21 are covered-nodes where N22, N23, and N24 are uncovered-nodes. The nodes N20-N24, N30, and N40 or other notation used herein may operate and be structured as nodes 210 discussed in FIG. 2.

As part of its execution, TR101-AG30 added a conditional IRV-entry in node N30, designating the search-value of ‘software engineer’. Then, TR101-AG30 continues with an index search on the profession index, seeking for all software engineers.

Jack's data-row is stored on N22, an uncovered-node. Jack has a profession of a dentist, a salary of 1400, and a height of 190 cm. A concurrently running writing-transaction TR1 modifies Jack's profession to software engineer. That effectively creates a move-in scenario. As already described hereinabove, TR1 should update both Jack's profession data-cell in node N22 and the pertinent profession index-entry in node N30. That is, TR1 uses the agents TR1-AG22 and TR1-AG30 to perform those write operations in N22 and N30, respectively. TR1-AG30 adds a corresponding IWV-entry to its IWV, and modifies Jack's profession index-entry in N30 to software engineer. In this case, TR1-AG30 detects the conditional IRV-entry issued by TR101-AG30 that designates the search-value ‘software engineer’, which is the “next version” of the index-entry that TR1-AG30 is writing, thus detecting an index-conflict. In an embodiment, that detection is performed during TR1's index-validation. It should be noted that an index-conflict is a case where the modification done by the index-writing agent (e.g., TR1-AG30) is “covered” by the search-value of an existing IRV-entry of another index-reading agent (e.g., TR101-AG30). In that example, when TR1-AG22 modifies Jack's profession to software engineer in N22, TR1-AG22 will not identify a move-in scenario because TR101 does not have a conditional RV-entry instantiated for TR101's predicate evaluation in N22, as N22 is an uncovered-node. Such a misidentification might result in an early commitment of TR1 over TR101, which may violate the various consistency expectations. In an embodiment, TR1-AG30 initiates a foreign instantiation of a conditional RV-entry in N22 for TR101's predicate evaluation of PR1010 (explained in more detail with respect to S520). That foreign instantiation will allow TR1 to correctly identify the move-in scenario, and, as a result, TR1 may not commit earlier than TR101.

In another embodiment, assuming the same conditions as in the original move-in scenario except that Jack's height is 170 cm, TR1-AG30's modification of Jack's profession in N30 to software engineer would not create a move-in scenario because his height is not covered by the predicate (that expects height to be greater than 180 cm). Instead, this would be a stay-out scenario. Thus, in this case, TR1 can commit earlier than TR101. However, when TR1-AG30 makes the modification, it does not detect that the conflict is actually of a stay-out state, as the information required for such a determination is not found in the index-node N30. As such, TR1-AG30 initiates a foreign instantiation of a conditional RV-entry in N22 for TR101's predicate evaluation, to accommodate the potential for a move-in scenario. When TR1-AG22 performs the data-validation, it detects the pertinent conditional conflict, and once it classifies its state by performing the epsilon checking procedure, it will detect the stay-out state. As a result, TR1 may commit earlier than TR101.

In another embodiment, assuming the same conditions as in the original move-in scenario for Jack (i.e., Jack's height is 190 cm, TR1 modifies Jack to be a software engineer, etc.) except that another concurrently-executing transaction, TR2, modifies Jack's height to 170 cm and TR2 is still in its working-phase. TR1-AG30 already initiated a foreign instantiation of a conditional RV-entry in N22 for TR101's predicate evaluation (as in the above example), and TR1-AG22, as part of its data-validation, identifies a move-in scenario. In this case, and according to the protective validation techniques, TR1-AG22 issues an inactive protective declaration and is conditionally dependent on TR101 in N22. When TR2 completes its working-phase and initiates its validation-phase, TR2-AG22, as part of its data-validation, discovers the foreignly instantiated conditional RV-entry for TR101's predicate and performs the epsilon checking procedure. In this case, TR2-AG22 detects that the conflict has a stay-out state and issues an active protective declaration. TR2 commits (it's an early commitment of TR2 over TR101). Then, TR2-AG22 removes its active protective declaration. As a result, TR1-AG22 is then able to re-perform the epsilon checking procedure and discovers a stay-out state for the conflict (because Jack's height is now 170 cm, so changing its profession to a software engineer will no longer create a move-in scenario). Therefore, TR1 can then commit earlier than TR101.

In another embodiment, assuming the same conditions as in the original move-in scenario except that Jack's data-row is stored in N21 (a covered-node for TR101's index search), TR1-AG30 modifies Jack's index-entry to software engineer in N30. TR1-AG30, in its index-validation, detects the conditional IRV-entry issued by TR101-AG30, but TR1-AG30 does not “know” that N21 is a covered-node (as the information required for such a determination is not found in the index-node N30). So, TR1-AG30 will initiate the foreign instantiation of the RV-entry for TR101's predicate in N21. However, given that TR101 already made sufficient progress in its execution and already instantiated the pertinent RV-entry in N21, this foreign instantiation may end up being detected as unnecessary because there already is a RV-entry instantiated in N21 for TR101's predicate. As a result, the foreign instantiation may be aborted. If TR101 has not made enough progress such that the pertinent RV-entry is not yet instantiated in N21, TR1-AG30's foreign instantiation of the RV-entry will take place and complete without aborting. In such a case, TR101-AG21 should not re-instantiate that RV-entry in N21, as it already exists there. In all those cases, TR1-AG21, in its data-validation, will detect a conditional conflict with TR101 and will classify it as a move-in state. As a result, TR1 will not be allowed to commit earlier than TR101.

In some embodiments, there is a stay-out scenario for a data-row in an uncovered-node that does not have an RV-entry instantiated for the predicate. The conditions are the same as in the original move-in example above. As in that example, Jack resides in N22 (uncovered node) and has a height of 190 cm, a profession of a dentist and a salary of 1400. The difference from that example is that the concurrently running writing transaction TR1 modifies Jack's profession to a carpenter. That effectively creates a stay-out scenario. As already described hereinabove, TR1 should update both Jack's profession data-cell in node N22 and the pertinent profession index-entry in node N30. That is, TR1 uses the agents TR1-AG22 and TR1-AG30 to perform those write operations in N22 and N30, respectively. TR1-AG30 adds a corresponding IWV-entry to its IWV, and modifies Jack's profession index-entry in N30 to carpenter. In this case, and as part of its index-validation, TR1-AG30 may not detect the conditional IRV-entry issued by TR101-AG30 as an index-conflict because the IRV-entry only covers the search-value of software engineer in N30, where the “next version” of the index-entry that TR1-AG30 is writing is ‘carpenter’. As a result, TR1-AG30 will not perform a foreign instantiation. Therefore, after TR1-AG22 modifies Jack's profession to carpenter in N22, and as part of its data-validation, TR1-AG22 may not detect any conflict with TR101, as N22 is an uncovered-node, and as such, N22 does not have a pertinent conditional RV-entry instantiated for TR101's predicate evaluation. By the lack of such a detected conditional conflict, TR1-AG22 will not explicitly identify this as a stay-out state. However, since there is no conflict with TR101, TR1-AG22 will complete its data-validation, take the commit pause, and progress to commitment. As a result, TR1 will commit earlier than TR101, and there may be no violation to the serializability and other expected consistency properties.

In another embodiment, assuming the same conditions as in the above stay-out scenario except that Jack's data-row is stored in N21 (a covered-node for TR101's index search). As in the previous example, TR1-AG30 will not perform a foreign instantiation, and for the very same reasons. However, N21 is a covered-node, and, as such, TR101-AG21 will exist and will instantiate a pertinent conditional RV-entry for its predicate evaluation. Therefore, TR1-AG21 may detect a conflict with that conditional RV-entry. TR1-AG21 may then perform the epsilon checking procedure and discover a stay-out scenario. The end result will be the same as in the above example. That is, TR1 may commit earlier than TR101. The difference from the previous example is that in this example, a conditional conflict was explicitly detected and then explicitly classified as a stay-out scenario.

In some embodiments, there is a move-out scenario for a data-row in a covered-node that does have an RV-entry instantiated for the predicate. The conditions are the same as the original move-in example above, except the focus is on Jane's data-row that is stored on N21, a covered-node by the index-search done by TR101. Jane has a profession of software engineer, a salary of 1400, and a height of 190 cm. A concurrently running writing transaction TR1 modifies Jane's profession to carpenter, thus effectively creating a move-out scenario. As already described hereinabove, TR1 should update both Jane's profession data-cell in node N21 and the pertinent profession index-entry in node N30. That is, TR1 uses the agents TR1-AG21 and TR1-AG30 to perform those write operations in N21 and N30, respectively. TR1-AG30 adds a corresponding IWV-entry to its IWV, and modifies Jane's profession in N30 to carpenter. In this case, and as part of its index-validation, TR1-AG30 may not detect the conditional IRV-entry issued by TR101-AG30 as an index-conflict because the IRV-entry only covers the search-value of a software engineer in N30, where the “next version” of the index-entry that TR1-AG30 is writing is ‘carpenter’. As a result, TR1-AG30 may not perform a foreign instantiation. The fact no foreign instantiation (into N21) takes place does not cause a problem, as N21 is a covered-node, and, as such, a pertinent conditional RV-entry will be added by TR101-AG21 anyways. Therefore, after TR1-AG21 modifies Jane's profession to carpenter in N21, and as part of its data-validation, TR1-AG21 may detect the pertinent conditional conflict, perform the epsilon checking procedure in N21 and discover a move-out scenario. As a result, TR1 will not be allowed to commit earlier than TR101.

In the alterative embodiment, there are the same conditions as the above example, with some different timing that may create a race condition. TR1-AG30 already modified Jane's index-entry to carpenter in N30 in an uncommitted manner, and TR1-AG21 already modified Jane's data-row to carpenter in N21 in an uncommitted manner. At time t=100, TR101-AG30 started a profession index search on N30 and discovered Jane because the currently committed value in the index-entry for Jane's data-row is still software engineer. For the race condition to occur, it should be noted that, in this example embodiment, TR101 has not yet created a transaction agent in node N21 (TR101-AG21). At time t=110, TR1 commits. As part of that commitment, the currently committed value of Jane's profession turns to “carpenter” in both the index-entry in N30, and in the data-row in N21. This commitment occurs because TR101 has not yet instantiated its agent TR101-AG21 in node N21 and hence hasn't yet instantiated the pertinent conditional RV-entry in N21. At time t=120, TR101-AG21 is created. Because TR101-AG30's index search in N30 at t100 discovered Jane as a software engineer, TR101-AG21 relies on the results of the index search and, once it scans the rows provided by the index search (for further narrowing down those with height >180 cm, and for any further actions to be done for the rows that satisfy the predicate PR1010), TR101-AG21 may select Jane, as the only remaining check TR101-AG21 needs to perform is regarding Jane's height (which is 190 cm, satisfying that part in the predicate). As a result, TR101-AG21 will select Jane for further processing, even though the currently-committed contents of her profession data-cell is carpenter. This scenario demonstrates a race-condition that effectively created a move-out scenario, where, TR1 was allowed to commit earlier than TR101, thus possibly violating various expected consistency principles.

In some embodiments, this race-condition is prevented by having TR101-AG21 re-read Jane's data-row for the committed content of the profession data-cell, that would be “carpenter,” rather than “blindly trusting,” the results of the index search that indicates that Jane's row ID may be part of the rows to be selected by the predicate. In an embodiment, TR101-AG21 performs this re-read as part of its table-node scan in N21 that it performs for narrowing-down the list of selected rows and/or for taking further actions for the selected rows. It should be noted that, for a similar reason, that re-read should also include the currently committed value of the salary data-cell. As a result, TR101 treats Jane as a carpenter and, therefore, does not select Jane. Therefore, TR1 committed earlier than TR101, and the scenario is no longer a move-out scenario.

In another embodiment, assuming the same race-condition as in the above example except that TR1 removes Jane's data-row, TR101-AG21's “re-read” of Jane's row will fail with a “row not found” reason, as the row no longer exists because TR1 removed the row and committed. This indicates that the row should not be selected by TR101's predicate.

In yet another embodiment, TR101-AG21 is created and instantiates a pertinent conditional RV-entry in N21 before TR1 commits. In this case, TR1-AG21 will detect the conditional conflict, perform the epsilon checking procedure, and discover a move-out scenario. As a result, TR1 will be dependent on TR101's commitment. Therefore, TR101 effectively executes when Jane's (currently-committed) profession is still a software engineer, and hence will select Jane's row in its predicate evaluation and in the related actions taken on the rows selected by the predicate. It should be noted that the re-reading of Jane's profession described hereinabove will return ‘software engineer’ as TR1 does not commit as it's dependent on TR101. After TR101's commitment, TR1 will be able to commit, thus modifying the contents of the data-cell for Jane's profession to carpenter.

In some embodiments, there is a stay-in scenario for a data-row in a covered-node that does have an RV-entry instantiated for the predicate. The conditions are the same as the original move-out example above for Jane. This time, however, a concurrently running writing transaction TR1 modifies Jane's salary to 1410 (where her salary was originally 1400), thus effectively creating a stay-in scenario. As already described hereinabove, TR1 should update both Jane's salary data-cell in node N21 and the pertinent salary index-entry in node N40. That is, TR1 uses the agents TR1-AG21 and TR1-AG40 to perform those write operations in N21 and N40, respectively. TR1-AG40 adds a corresponding IWV-entry to its IWV and modifies Jane's salary in index-node N40 to 1410. TR101-AG40 already added a conditional IRV-entry in N40 denoting a search-value range of 1000-1499 for the salary index. In this case, and as part of its index-validation, TR1-AG40 may detect the conditional IRV-entry issued by TR101-AG40, and identify it as an index-conflict, as the TR1's “next version” salary value of 1410 is within the IRV-entry's search-value range (1000-1499). Because TR1-AG40 does not “know” that N21 is a covered-node by the predicate's index-search (as the information required for such a determination is not found in the index-node N40), TR1-AG40 identifies a potential for a move-in scenario (such a move-in scenario was demonstrated and discussed hereinbefore) in potentially an uncovered-node. It should be noted that in this scenario, N21 is a covered-node and there is no move-in scenario, but as mentioned above, TR1-AG40 does not “know” that. Therefore, and regardless, TR1-AG40 initiates a foreign instantiation (discussed below) of TR101's RV-entry in N21, thus allowing TR1-AG21 to identify the conflict (during its data-validation). However, if, as in this case, there already was a pertinent RV-entry instantiated in N21, this foreign instantiation is unnecessary and is therefore stopped. As such, TR1-AG21, in its data-validation, identifies the conditional conflict, and its epsilon checking procedure in N21 will result in a stay-in scenario. As a result, TR1 is allowed to commit earlier than TR101, as the stay-in scenario here means that TR101 would select Jane regardless of whether her salary is 1400 or 1410. It should be noted that in the case that TR101-AG21 has not already instantiated the RV-entry in N21, TR1-AG40's initiation of the foreign instantiation of TR101's RV-entry in N21 will not be stopped (explained in more detail in reference to S520).

In another embodiment, if TR1-AG40 modifies the index-entry in N40, as well as performs the related index-validation, prior to TR101-AG40 adding the pertinent conditional IRV-entry and performing the index search, then TR101-AG40 “notifies-for-index-validation” TR1-AG40 about its index search activity. A “notification-for-validation” is used to denote that TR101-AG40 notifies TR1-AG40 so that TR1-AG40 can perform the validation. In an embodiment, this is done through the addition of an IRV-entry that effectively represents a conflict between TR1 and TR101. In another embodiment, TR101-AG40 may actually perform validation acts for TR1-AG40. “Notification-for-index-validation” is described in detail hereinbelow.

At S510, all index-conflicts between the index-validating TR1-AG30 and its related conflicting reading-transactions are identified. In an embodiment, TR1-AG30 exists on N30. Index-conflicts are identified by TR1-AG30 performing an iterative scan over all of TR1-AG30's IWV-entries in N30. TR1-AG30 detects index-conflicts between the IWV-entries and IRV-entries. For each such identified index-conflict, execution may proceed with S520, but iterative scanning for other conflicts may continue.

In one embodiment, index-conflicts are found when TR1-AG30 identifies that it wrote to an index-entry with a “next version” value that is covered by the search-values associated with a conditional IRV-entry entered by reading-transaction TR101. In an embodiment, a conditional IRV-entry is added to the IRV on an index-node by TR101's agent TR101-AG30. The original move-in scenario demonstrates this embodiment.

In another embodiment, if TR1-AG30 modifies the index-entry in N30 prior to TR101-AG30 performing the index search, then TR101-AG30 “notifies-for-index-validation” TR1-AG30 about its index search activity. A “notification-for-index-validation” is used to denote that TR101-AG30 notifies TR1-AG30 so that TR1-AG30 can perform the index-validation for the intended index read/search. In an embodiment, this is done through the addition of an IRV-entry that effectively represents an index-conflict between TR1 and TR101. In another embodiment, TR101-AG30 may actually perform index-validation acts for TR1-AG30.

At S520, for each identified index-conflict, a foreign instantiation is initiated. In an embodiment, according to the original move-in scenario, a foreign instantiation is originated by TR1-AG30, which modified an index-entry of row R100 due to an index-conflict it detected with a reading-transaction TR101, where the data-row for row R100 is stored on table-node N22. A request is sent by TR1-AG30 to, for example, TR101's transaction manager (TR101-TM) to create an agent in N22 (TR101-AG22) if one is not already created. In an alternative embodiment, TR1-AG30 does not communicate with TR101-TM directly. Instead, TR1-AG30 communicates with node N22, providing N22 with all the information required for the foreign instantiation (e.g., the predicate (PR1010), the identity of TR101 and TR1, etc.). N22 checks if TR101-AG22 already exists, and, if not, N22 communicates with TR101-TM, requesting TR101-TM to create TR101-AG22. Such a request is important to ensure that TR101-TM will include TR101-AG22 in TR101-TM's transaction activities (such as TR101 commitment). In that case, TR101 then creates TR101-AG22.

TR101-AG22 then instantiates the pertinent conditional RV-entry of TR101 that was required by the foreign instantiation request-if such an RV-entry does not already exist. During TR1-AG22's validation-phase in N22, and as part of its data-validation, TR1-AG22 will detect the conflict with the foreignly instantiated conditional RV-entry in N22. The addition of that conditional RV-entry should be performed in the same way it would be performed if TR101-AG22 were to perform the predicate evaluation (although that evaluation is not required). For example, notification-for-validation, if needed, should be performed. For example, if TR1-AG22 is currently in its data-validation, such a notification-for-validation may be required by the protective validation techniques.

In an embodiment, TR1-AG22, which detected the conditional conflict with the pertinent foreignly instantiated RV-entry, may perform an epsilon checking procedure. Depending on the exact scenario, it may detect that the epsilon principle is not satisfied due to a possible move-in scenario. As such, TR1 will not be able to commit earlier than TR101. Alternatively, the epsilon checking may be satisfied, for example, due to a stay-in scenario. As such, this conditional conflict may not block TR1 from committing.

For the cases described above, TR1-AG22's validation of the pertinent conditional conflict will happen according to the disclosed techniques, such as the disclosed protective validation techniques. Additionally, there is the case where the foreignly-instantiated RV-entry is added when TR1-AG22 already finished its validation-phase in N22 and holds a commit pause. In that case, TR1 may not commit, as TR1-AG30 won't take its commit pause before the entire foreign instantiation completes. In that case, this commit pause is broken so that TR1-AG22 does not miss the conflict. In an embodiment, TR101-AG22 requests that TR1-AG22 breaks the commit pause. If a notification-for-validation is sent (as described herein), then this request is sent before such notification-for-validation. TR1-AG22 may contact TR1-TM to make the request, and TR1-TM approves and sends the request. In an embodiment TR1's transaction manager TR1-TM is requested to coordinate that commit-pause break. Once TR1-AG22's commit pause is broken, TR1-AG22 performs any validations, such as the one for the foreignly-instantiated RV-entry. Depending on the results, TR1-AG22 may then re-take the commit pause or be dependent, e.g., on TR101.

Once the pertinent RV-entry was instantiated, N22 (e.g., TR1-AG22) may update TR1-AG30 about the completion of the foreign instantiation. It should be noted that in the case TR1-AG22 already held the commit pause and the commit pause had to be broken, this notification to TR1-AG30 should be postponed until the commit pause is broken. As described hereinafter, TR1-AG30 will not progress to commitment before all the foreign instantiations it originated are completed.

In an embodiment, TR1-AG30, in its index-validation, may perform an index-conflict identification and may perform the index-conflict handling (e.g., initiating a foreign instantiation), asynchronously as long as, for each identified conflict, a foreign instantiation is initiated and performed before TR1 proceeds to commitment. In an embodiment, as long as TR1-AG30's index-validation process will not complete until all the index-conflicts it needs to identify are identified and the foreign instantiations it initiated are performed and complete, TR1-AG30 will not take the commit pause and will not send a (index) validation completion message to TR1's transaction manager, thus not allowing TR1 to proceed to commitment.

In an embodiment, assuming the same conditions as in the example above except when the foreign instantiation is initiated, it is discovered that the reading-transaction TR101 already committed. In that case, the foreign instantiation is no longer required and is hence stopped. It should be noted that if the foreign instantiation progressed such that TR101-AG22 was already instantiated, then a commitment of TR101 can commence at a later stage.

In yet another embodiment, assuming the same conditions as in the example above except when the foreign instantiation is initiated, all TR101 agents took commit pauses, and TR101-TM can decide to make TR101 “committing-in-progress”, thus TR101-TM is starting to take actions to commit the transaction. In such a case, it may, in some embodiments, be disadvantageous, or even impossible, to perform an instantiation of TR101-AG22 during such a “committing-in-progress” state of TR101. It should be noted that the foreign instantiation request in N22 could be performed, if the foreign instantiation request arrived earlier than the “committing-in-progress” state. If the request is made before the “committing-in-progress” state, TR101-TM may continue with its commitment as long as the foreign instantiation is complete. In an embodiment, if the request for the foreign instantiation is received after “committing-in-progress” began, (that is, during the “committing-in-progress” state), then TR101-TM may choose to handle the foreign instantiation request after TR101's “committing-in-progress” completes, e.g., after TR101 commits, after TR101 aborts, or after TR101's commitment is aborted with the intention to commit later. Then, in an embodiment, if TR101's commitment is aborted with the intention to commit later, TR101-TM may continue with the foreign instantiation. In another embodiment, if TR101's commits or aborts, then continuing with the foreign instantiation is not required. However, TR101-TM should then notify TR1-AG30 that the foreign instantiation was stopped. In an embodiment, that notification should occur only after TR101's commitment or abortion. It should be noted that, in such a case, TR1-AG30 should wait until receiving that notification, and only then conclude that that specific foreign instantiation is completed.

According to various embodiments, foreign instantiation is a component of the sufficient-instantiation technique. The sufficient-instantiation technique refers to TR101's respective agents dynamically adding conditional RV-entries in each of the table-nodes that are required (sufficient) for correctness and consistency of transactions.

In an embodiment, TR1 may commit prior to TR101-AG30 adding the IRV-entry in N30. In this case, TR1 will not be able to use that IRV-entry. However, there will be no violation of consistency principles. For example, in the original move-in example given hereinabove, there will be no violation of consistency principles because TR101-AG30 will identify Jack in its index search. It should be noted that even though TR1's commitment took place earlier than TR101-AG30's index search, TR101-AG30 adds the IRV-entry in N30 before it performs the index search.

At S530, it is determined whether the TR1-AG30 can proceed to commitment. This includes checking various conditions, including, but not limited to, waiting until all index-conflicts are handled, including those that were detected by the help of notification-for-index-validation, and waiting until all the related foreign instantiations are complete.

At S540, a commit pause is placed on the index-entries modified by the validating-transaction TR1. Placing the commit pause allows the transaction to progress to the commit-phase. In an example embodiment, the placement of commit pause is achieved atomically with the conclusion that all validation conditions are met at S530.

In an embodiment, a node, e.g., N50 may be both an index-node and a table-node. TR1-AG50 performs both modifications to the data cells in the data tables stored in N50 and to the index-entries stored in the index in N50. In that case, TR1-AG50 is performing data-validation and index-validation. As already discussed hereinbefore, in some embodiments, it may be advantageous to treat these two validations as separate.

In other embodiments, it may be advantageous to converge the interactions with TR1-TM and to converge the timing of commit pauses. For example, TR1-AG50 completes its index-validation and is able to take the pertinent commit pauses. TR1-AG50 may wait to take the pertinent commit pauses until TR1-AG50 completes the data-validation and is able to take the pertinent commit pauses.

It should be noted that in an embodiment, the commitment process for TR1 may be paused for as long as the reading transactions it depends on do not complete their execution, that is, until those reading transactions commit or abort. For example, the determination that a conditional conflict is in a move-in state will lead to a dependency of TR1 on the corresponding reading-transaction. This pause is initiated in order to preserve concurrency control and prevent the committed values of TR1 from compromising data integrity.

In some embodiments, when TR1-AG10, for example, holds a commit pause, other processes in N10 may block. As such, it may be advantageous for TR1-AG10 to hold the commit pause only for short periods. For example, TR1 has two agents: TR1-AG10 and TR1-AG11, where both performed write operations for TR1. TR1-AG10 took the commit pause while TR1-AG11 is still validating. TR1-AG11 has a non-conditional dependency on TR2-AG11. If TR2 takes a long time to commit, TR1-AG11 will have to take a long time to take a commit pause. In this case, it may be that TR1-AG10 has been holding the commit pause for a time longer than optimal (as TR1 can commit only after all its agents that perform write operations take the relevant commit pauses).

In such a case, one embodiment includes TR1-TM issuing an instruction for TR1-AG10 to break the commit pause. If TR1-AG10 breaks its commit pause, it will need to detect any new conflicts. According to various embodiments, TR1-TM in conjunction with TR1's agents may issue the instruction at an optimal time. According to these embodiments, it is important to note that TR1-TM will continue to commitment only if all of TR1's agents hold all the corresponding commit pauses and will not break the commit pauses until TR1-TM's commitment ends.

In some embodiments, after TR1 commits, TR1's agents take various actions including, but not limited to, releasing commit pauses that the agents took, resolving all dependencies of other transactions on TR1 in various nodes, performing a “cleanup” of the resources (e.g., RV and WV) of TR1's agents, and performing other “post commit” activities that are required by a database implementation.

In another embodiment, once TR101 commits, TR101-AG40, for example, on index-node N40, is informed of TR101's commitment. TR101-AG40 may identify all transaction agents in N40, such as TR1-AG40, that had index-conflicts with TR101's index search. In an embodiment, TR101-AG40 may notify the identified agents on TR101's commitment, and those agents may then react by, for example, cancelling activities that are not required anymore. If TR1-AG40 has not yet detected a conflict with TR101-AG40's index search in N40, then TR1-AG40 need not perform further action in regard to index-conflicts with TR101. Once TR1-AG40 is informed by TR101-AG40, if TR1-AG40 already detected a conflict with TR1-AG40's index search and has not yet initiated the related foreign instantiation, then TR1-AG40 may not be required to initiate it. Additionally, if such a foreign instantiation is already in progress, TR1-AG40 may abort it (in one embodiment) or let the foreign instantiation continue (in another embodiment).

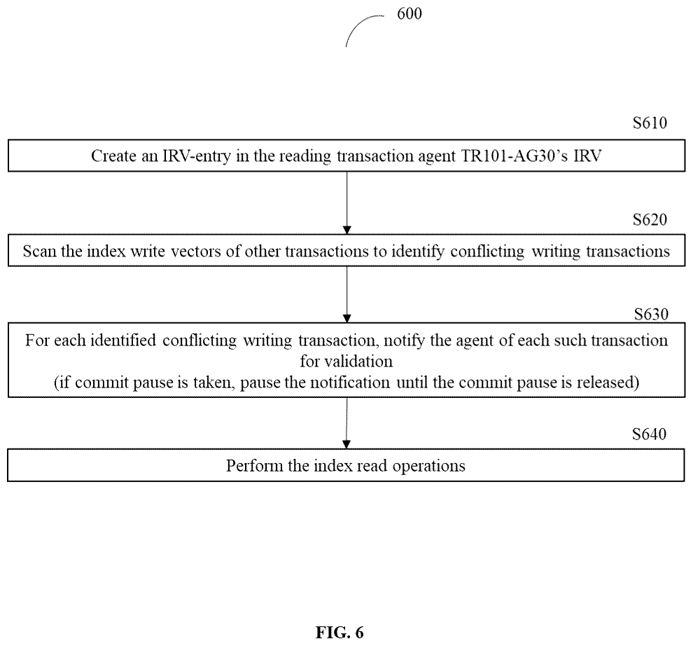

FIG. 6 illustrates an example flowchart 600 of a process for performing an index read/search in the sufficient-instantiation technique according to an embodiment. In an embodiment, the index read is an index search performed by TR101's agent in an index-node, for example, TR101-AG30 in node N30. As explained above, indexes are used to identify and/or narrow down the data-rows that are required to be searched as part of a predicate evaluation.

At S610, a conditional IRV-entry is added to the TR101's RV in the index-node. As described hereinbefore, this conditional IRV-entry describes the corresponding search-value(s) associated with the specific index-search. In an embodiment, this conditional IRV-entry designates and describes the entire predicate that caused TR101 to access that index-node (N30) as part of the predicate evaluation.

At S620, all index-conflicts between TR101 and other writing-transactions in N30 that arise from the intended index-search of TR101-AG30 are identified. That is, all the writing-transactions with agents in N30 that modified an index-entry with a “next version” value that is covered by the search-value of the intended index-search that TR101-AG30 is about to perform are identified. For example, such identification may include scanning the IWV-entries of writing-transactions that conflict with the IRV-entry to identify such writing-transactions. In an embodiment, this scanning of the IWV-entries of transactions is performed by TR101.

At S630, for each such identified index-conflict, the transaction agent associated with the index-validating transaction, e.g., TR1-AG30, is notified about the addition of the conditional IRV-entry that effectively represents an index-conflict between TR1 and TR101. In an embodiment, TR101 notifies validating-transaction TR1's agent TR1-AG30 so that TR1-AG30 can perform the index-validation (‘notification-for-index-validation’). In some embodiments, TR101-AG30 actually performs index-validation acts for TR1-AG30. As already described hereinbefore, an index-validation may involve the initiation of a foreign instantiation, and may cause TR1-AG30 not to progress to commitment until that index-conflict is fully handled, including until the related foreign instantiation is completed.

In an embodiment, if TR1-AG30 holds a commit pause on the index-entries that TR1-AG30 modified and are related to the index-entries whose intended reading is represented by TR101-AG30's notification-for-index-validation, then TR101-AG30's notification to TR1-AG30 may be delayed until the related commit pause(s) is released. In an embodiment, the process will not progress to S640 until that notification-for-index-validation takes place. As discussed hereinbefore, TR1-AG30 may release the commit pause(s) for a variety of reasons. If the commit pause(s) was released because TR1 committed or aborted, then TR101-AG30's notification-for-index-validation to TR1-AG30 may not be required anymore, as the related index-conflict no longer exists.

In some embodiments, if TR1's index-validation has not yet processed the pertinent index-conflict, TR1 may ignore the notification from TR101, and that specific index-validation may be performed later.

At S640, index read operations are performed. In some embodiments, TR101's agent TR101-AG30 performs the index read.

It should be noted that in order for the early commit of TR1 to satisfy concurrency control requirements, the evaluation of the predicate of TR101 should follow a set of conditions. The set of conditions may be denoted as the single predicate evaluation consistency principle. It should be further noted that the above disclosed embodiments with respect to the process in example flowchart 600 of FIG. 6 function according to the predicate evaluation consistency principle.

In an embodiment, the predicate evaluation consistency principle applies when a predicate that is evaluated as part of a statement execution is evaluated for one or more data cell sets where each data cell set may contain one or more data cells. According to this principle, the following conditions hold for each separate predicate evaluation of a specific data cell set.

First, for each such predicate evaluation of a single data cell set, the data that is read to evaluate the predicate belongs to the same set of database data cells as the set that exists at a single specific point in time that is denoted as the virtual read timepoint. That is, if, for example, a predicate data-cell set contains two data-cells, [Jane's profession and Jane's hair-color], then the read contents of the two data-cells must be the committed contents of those data-cells for the very same point in time, namely the virtual read timepoint. However, it should be noted that if the predicate evaluates multiple data-cell sets, then the virtual read timepoint of each data-cell set may be different.

Second, the virtual read timepoint is at a later time than the time that the conditional RV-entry was added to a TR101's RV. That also means that TR101 adds the corresponding conditional RV-entry to its RV before it performs any related reads that are required for the predicate evaluation. Third, the virtual read timepoint is at an earlier time than the time of usage of the predicate evaluation results.

As mentioned above, performing the process of an index read may be followed by various operations. Index search results may be further processed by, for example, intersecting row ID lists, unifying row ID lists, etc. As a result of this furthering processing, additional processing may be performed in the relevant table-nodes that contain the row IDs that correspond to the index values that were read. In the table-nodes, the rows selected by the index search are read in order to be, for example, further narrowed down to the selected rows in case the predicate contained columns that were not indexed or were not otherwise checked by the index search.

In an embodiment, the subsequent data-row read is a separate, consistent read than the index search, and the data-row read also performed in compliance with the predicate evaluation consistency principle.

Furthermore, for embodiments that employ the use of Point-in-Time (PiT) reads or copies, conditional IRV-entries are added in the various index-nodes before PiTs are created.

Additionally, according to the various disclosed embodiments, pseudo-deadlocks can occur between two, or more validating transactions. Pseudo-deadlocks are described in detail in the above-referenced application Ser. No. 18/945,062. Pseudo-deadlocks are modified as discussed herein.

In a distributed database, in an embodiment, a pseudo-deadlock may occur involving only agents that execute on the same table-node (e.g., TR1-AG10 and TR2-AG10). Such a pseudo-deadlock may be denoted as “non-distributed pseudo-deadlock”. In another embodiment, a pseudo-deadlock may occur in a way that involves a plurality of table-nodes (two or more table-nodes), involving agents that execute in a plurality of table-nodes (e.g., TR1-AG21, TR1-AG22, TR2-AG21, and TR2-AG22). Such a pseudo-deadlock may be denoted as “distributed pseudo-deadlock”.

In an embodiment, a non-distributed pseudo-deadlock may be handled as it is handled in a non-distributed database, as described in detail in the above-referenced application Ser. No. 18/945,062.

In an example embodiment, the following distributed pseudo-deadlock occurs. TR101 and TR102 are reading-transactions whose execution is still in progress—e.g., still in their working phase. TR101 has agents in table-nodes N21 and N22, and so does TR102. Those four agents perform data-access activities. TR1 and TR2 are writing transactions that currently perform data-validation. TR1 has agents in table-nodes N21 and N22, and so does TR2. It should be noted that challenging, as well as any pseudo-deadlock handling techniques are not in use.

At time t=100, TR1-AG21 issued an active protective declaration on [PR1010*DCS1] sourced by TR101. Then, at time t=110, TR2-AG22 issued an active protective declaration on [PR1020*DCS2] sourced by TR102.

Then, at time t=120, TR1-AG22 wants to validate for early-commitment [PR1020*DCS2]. Since it's currently protected (by TR2-AG22), TR1-AG22 issues an inactive evaluation-pending protective declaration on [PR1020*DCS2]. Then, at time t=130, TR2-AG21 wants to validate for early-commit [PR1010*DCS1]. Since it's currently protected (by TR1-AG21), TR2-AG21 issues an inactive evaluation-pending protective declaration on [PR1010*DCS1].

Then, at time t=140, TR1-AG22 completed all its other data-validation tasks and only waits on evaluation-pending of [PR1020*DCS2]. Then, at time t=150, TR2-AG21 completed all its other data-validation tasks and only waits on evaluation-pending of [PR1010*DCS1].

As a result, as long as TR101 and TR102 do not complete their execution (either commit or abort), TR1 and TR2 are in a pseudo-deadlock situation. Depending on the contents TR1 and TR2 wrote, it may be possible that TR1 or TR2 could have early committed over TR101 and/or TR102. The deadlock is a “pseudo” one because, once TR101 (or TR102) commits, the pseudo-deadlock may be released.

In one embodiment, no actions are taken, and a pseudo-deadlock is therefore held until it is resolved by itself, as described hereinabove.

In another embodiment, techniques such as lexicographical ordering of data-validations may be used, thus avoiding pseudo-deadlocks. It should be noted that such techniques may require further coordination with regard to the order of data-validations performed across the nodes.

In yet another embodiment, a standard deadlock detection search is performed. This approach includes detecting a directed cycle in a graph that represents waiting of agents on other agents in the context of active protective declarations. According to one embodiment, once a directed cycle is found, one agent participating in the cycle is identified, and a “sanction” against it includes cancelling the relevant active protective declaration or forcing one of the waiting agents AG1 to agree to a challenge of another agent AG2 that participates in the pseudo-deadlock and that is waiting on AG1's active protective declaration.

In yet another embodiment, forced challenging can be used just as in a non-distributed database to prevent deadlocks between transactions (as described in the above-referenced application Ser. No. 18/945,062, with some modifications). Modifications to forced challenging include but are not limited to the embodiments discussed hereinbelow.

In an embodiment, a forced challenging technique is implemented. Such technique involves assigning each transaction a challenge rank, such that no two transactions have the same challenge rank and those with lower challenge ranks are “stronger” transactions than those with higher challenge ranks. In an embodiment, all the agents of the same transaction have the same challenge rank, that is the challenge rank of their transaction.

In an embodiment, the transaction manager of each transaction (e.g., TR1) sets the challenge rank of the transaction once it begins TR1's validation phase, and informs its agents about their challenge rank. To ensure uniqueness of challenge rank among the transactions, and since the various transaction managers may reside on different nodes, the transaction manager of TR1 may choose a challenge rank that is unique across all the transaction managers that reside in that node (hereinafter, “the MSB part”), further amending an LSB portion for the challenge rank that contains a unique identification of the node it resides in (hereafter “the LSB part”).

In an embodiment, the MSB part of the challenge rank is set according to the timing a transaction started its validation, such that a transaction is “stronger” than another if it started its validation process earlier. It should be noted that even if the challenge rank only approximately represents the timing the transaction started its validation, the advantages of such an approach remain. In an embodiment, the MSB part is determined by a clock that is synchronized across the database nodes. It should be noted that the clock synchronization need not be very accurate, due to all the reasons mentioned hereabove. It should be noted that such a synchronized clock may represent real time, or be a logical clock, and so forth.

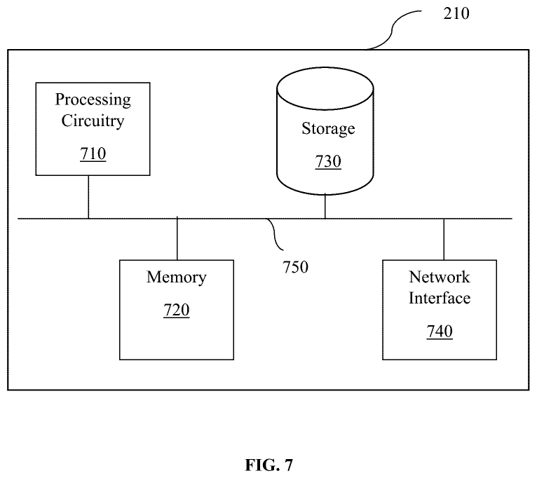

FIG. 7 is an example schematic diagram of a hardware layer of node 210 in a database 120 according to an embodiment. The node 210 includes a processing circuitry 710 coupled to a memory 720, a storage 730, and a network interface 740. In an embodiment, the components of the node 210 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 740 allows the node to communicate with, for example, other nodes or with a transaction manager. It should be understood that the embodiments described herein are not limited to the specific architecture illustrated in FIG. 7, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to and executed by a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program or any combination thereof, which may be executed by a CPU, whether such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for managing execution of database transactions in a distributed database system, wherein the distributed database system includes at least one index-node and at least one table-node, comprising:
during an index-validation process on index write operations of a transaction, identifying index-conflicts between a transaction and at least one reading-transaction;
for each identified index-conflict, initiating a foreign instantiation to determine if the transaction can commit before the at least one reading-transaction; and
upon completing the foreign instantiations on all identified index-conflicts and when validation conditions are met, placing a commit pause on the index-entries modified by the transaction.

2. The method of claim 1, further comprising:
initiating the foreign instantiation of a read-vector entry (RV-entry) in a table-node, wherein the RV-entry corresponds to a predicate of a reading-transaction performing an index search on an index node.

3. The method of claim 2, wherein initiating the foreign instantiation further comprises:
for each foreign instantiation, checking if a transaction agent is instantiated for the reading-transaction on the respective table-node; and
causing instantiation of a transaction agent for the at least one reading-transaction in the respective table-node, when there is no transaction agent for the reading-transaction instantiated on the respective node.

4. The method of claim 3, wherein the foreign instantiation further comprises:
instantiating, by a transaction agent for the at least one reading-transaction, a conditional read vector entry (RV-entry) corresponding to a predicate of the at least one reading-transaction in the respective table-node that maintains data-rows.

5. The method of claim 1, wherein identifying the index-conflicts further comprises:
identifying conflicts between an index read vector entry (IRV-entry) and an index write vector entry (IWV-entry), wherein the IWV-entry corresponds to a next version of index-entries modified by the transaction that is covered by a search-value, and wherein the IRV-entry corresponds to a search-value of an index search performed by the at least one reading-transaction as part of a predicate evaluation.

6. The method of claim 5, further comprising:
adding a conditional index read vector entry (IRV-entry) to the index read vector (IRV) of each of the at least one reading-transactions;
identifying index-conflicts between the at least one reading-transaction and conflicting writing-transactions in the index-node;
for each identified index-conflict, notifying a transaction agent for the index-validating transaction about the addition of the conditional IRV-entry, wherein the transaction agent is instantiated on the index-node that is to be searched; and
performing index read operations on the index-node.

7. The method of claim 1, wherein validation conditions include: all index-conflicts are handled, including those that were detected through a notification-for-validation; and all foreign instantiations are complete.

8. The method of claim 1, further comprising:
committing the transaction immediately after placing the commit pause on data cells and index entries modified by the transaction.

9. The method of claim 1, further comprising:
resolving pseudo-deadlocks by applying a forced challenging procedure.

10. A non-transitory computer-readable medium storing a set of instructions for managing execution of database transactions in a distributed database system, the set of instructions comprising:
one or more instructions that, when executed by one or more processors of a device, cause the device to:
during an index-validation process on index write operations of a transaction, identify index-conflicts between a transaction and at least one reading-transaction;
for each identified index-conflict, initiate a foreign instantiation to determine if the transaction can commit before the at least one reading-transaction; and
upon completing the foreign instantiations on all identified index-conflicts and when validation conditions are met, place a commit pause on the index-entries modified by the transaction.

11. A system for managing execution of database transactions in a distributed database system comprising:
one or more processors configured to:
during an index-validation process on index write operations of a transaction, identify index-conflicts between a transaction and at least one reading-transaction;
for each identified index-conflict, initiate a foreign instantiation to determine if the transaction can commit before the at least one reading-transaction; and
upon completing the foreign instantiations on all identified index-conflicts and when validation conditions are met, place a commit pause on the index-entries modified by the transaction.

12. The system of claim 11, wherein the one or more processors are further configured to:
initiate the foreign instantiation of a read-vector entry (RV-entry) in a table-node, wherein the RV-entry corresponds to a predicate of a reading-transaction performing an index search on an index node.

13. The system of claim 12, wherein the one or more processors, when initiating the foreign instantiation, are configured to:
for each foreign instantiation, check if a transaction agent is instantiated for the reading-transaction on the respective table-node; and
cause instantiation of a transaction agent for the at least one reading-transaction in the respective table-node, when there is no transaction agent for the reading-transaction instantiated on the respective node.

14. The system of claim 13, wherein the foreign instantiation further comprises:
instantiating, by a transaction agent for the at least one reading-transaction, a conditional read vector entry (RV-entry) corresponding to a predicate of the at least one reading-transaction in the respective table-node that maintains data-rows.

15. The system of claim 11, wherein the one or more processors, when identifying the index-conflicts, are configured to:
identify conflicts between an index read vector entry (IRV-entry) and an index write vector entry (IWV-entry), wherein the IWV-entry corresponds to a next version of index-entries modified by the transaction that is covered by a search-value, and wherein the IRV-entry corresponds to a search-value of an index search performed by the at least one reading-transaction as part of a predicate evaluation.

16. The system of claim 15, wherein the one or more processors are further configured to:
add a conditional index read vector entry (IRV-entry) to the index read vector (IRV) of each of the at least one reading-transactions;
identify index-conflicts between the at least one reading-transaction and the conflicting writing-transactions in the index-node that is to be searched as part of the predicate evaluation;
for each identified index-conflict, notify a transaction agent for the index-validating transaction about the addition of the conditional IRV-entry, wherein the transaction agent is instantiated on the index-node that is to be searched; and
perform index read operations on the index-node.

17. The system of claim 11, wherein validation conditions include:
all index-conflicts are handled, including those that were detected through a notification-for-validation; and
all foreign instantiations are complete.

18. The system of claim 11, wherein the one or more processors are further configured to:
commit the transaction immediately after placing the commit pause on data cells and index entries modified by the transaction.

19. The system of claim 11, wherein the one or more processors are further configured to:
resolve pseudo-deadlocks by applying a forced challenging procedure.
